(19) United States
(12) Patent Application Publication
(10) Pub. No.: US 2013/0132165 A1
(43) Pub. Date: May 23, 2013

(54) COMPUTER SYSTEM AND METHOD FOR CTQ-BASED PRODUCT TESTING, ANALYSIS, AND SCORING

(71) Applicants: David McNeill, Norcross, GA (US); Jon Peterson, Norcross, GA (US); Robert Ferrell, Norcross, GA (US)

(72) Inventors: David McNeill, Norcross, GA (US); Jon Peterson, Norcross, GA (US); Robert Ferrell, Norcross, GA (US)

(73) Assignee: 4th Strand LLC, Norcross, GA (US)

(21) Appl. No.: 13/561,916

(22) Filed: Jul. 30, 2012

Related U.S. Application Data
(60) Provisional application No. 61/513,617, filed on Jul. 31, 2011.

(51) Int. Cl. G06Q 10/06

(52) U.S. Cl. CPC G06Q 10/06393
USPC 705/7.39

(57) ABSTRACT

A computer system and method for product testing, analysis and scoring wherein the method includes defining at least one critical to quality (CTQ) parameter for product performance, defining a product test plan to verify product performance against one or more CTQ parameters, conducting and monitoring product testing, determining relative index performance scores, constructing a scorecard for products tested, and optionally modifying the product scorecard. The system and method is useful for clients (i.e. store retailers or merchants), product vendors (i.e. product manufacturers or distributors of products), testing laboratories, customers (i.e. direct consumers of the products), and product performance intermediaries (i.e. testing coordinators and testing data analysts). This system and method allows these parties to interact, exchange information, and display information in tabular and graphical formats for determining how similar products perform relative to each other.

### PRIORITY AND RELATED APPLICATIONS STATEMENT

Priority under 35 U.S.C. §119(e) is claimed to U.S. provisional application entitled “Computer System and Method for CTQ-Based Product Testing, Analysis, and Scoring,” filed on Jul. 31, 2011 and assigned U.S. provisional application Ser. No. 61/513,617. The entire contents of this provisional patent application are hereby incorporated by reference.

### BACKGROUND

Systems and methods exist for valuing products based on demand probabilities. Products can be designed by identifying product components and combining the components in various combinations to provide standard and non-standard products. Components can then be valued using algorithms that consider demand probability as well as known prices of standard products. Component values can be added to determine product values and may then be used to make pricing and order fulfillment decisions. Similar systems and methods are often directed toward valuing resources used in the manufacture of one or more products. Such systems and methods are directed toward product valuation based upon product materials and manufacture rather than product performance toward meeting customer critical to quality (“CTQ”) parameters.

Many conventional product valuation methods only provide the customer with predetermined evaluation criterion, and do not allow criterion to be selected that might represent customer CTQs as perceived by a combination of customers, vendors, retailers and third-party product evaluators. Conventional product valuation methods often do not consider input and opinions from retailers, vendors and customers toward meeting customer CTQs, nor do they provide a means to define product tests that can be used to evaluate product attributes against CTQs.

In addition to conventional product valuation methods, consumers and retailers are often provided with product laboratory test data for products. Prior art methods for test laboratory reporting of product tests often include detailed textual reports with numerous figures and many pages of results.

For example, Underwriters Laboratories publishes reports that can describe product conformance to applicable product performance and safety standards. Although thorough, these reports are usually very difficult for a product retailer to utilize in a comparison of similar products. Further, product evaluation criterion often will not provide evaluation against product CTQs but instead are focused on individual product attributes. If a given product requires multiple evaluation tests, individual tests can often be conducted by different tests labs. Each test lab can have its own report format which further compounds the problem of consolidating and comparing test data for the given product in a concise “at a glance” format. Much of this type of testing is against a pass/fail standard. If all vendors pass, usually the retailer has does not receive any test output data with actual numbers. If a retailer was provided with actual numbers for the test output data, then such data could improve a retailer's negotiation ability against any particular product vendor.

Accordingly, there is a need in the art to provide an integrated system and method for product evaluation, comparison, scoring and valuation wherein input from retailers, vendors, customers and product performance intermediaries (PPIs) can all be considered toward defining product attributes that customers perceive to be CTQs. Customers can include product purchasers and/or product users. There is a further need for a system and method for planning and facilitating product testing and reporting wherein PPIs can determine test plans consisting of one or more product tests that can evaluate one or more products against customer CTQs, and then one or more test laboratories can conduct the product tests and report test data in a consolidated manner.

There is a further need for a system and method to determine product relative index performance scores (“RIPS”) from information that includes product test data, for constructing scorecards, for visually displaying the RIPS and scorecards in one or more concise formats, and for making selected changes to scorecards including changes to statistical calculations and changes to visual displays.

### SUMMARY OF THE INVENTION

The inventive system and method solves the aforementioned problems by providing a computer system and portals for users that can include clients (i.e. product retailers who sell products from a range of different vendors), vendors (i.e. manufacturers and/or distributors of products), test labs, customers (i.e. direct consumers of products), and product performance intermediaries (“PPIs”, i.e. testing coordinators). The system allows customers and clients to interact with the PPIs; upload and download information; execute product evaluation and scoring calculations and algorithms; construct graphical depictions of evaluation and scoring results; and to view and edit data, information and product evaluation results. User portals may provide a visual display and can also provide user input devices.

Product PPIs (i.e. testing coordinators) may commission surveys on the behalf of clients (i.e. product retailers who sell products from a range of different vendors) whereby the computer system and user portals can provide a system and method for clients (i.e. product retailers who sell products from a range of different vendors), vendors (i.e. product manufacturers and/or product distributors), test labs and/or customers (direct consumers of products) to supply product information. Computer code may be executed the inventive computer system wherein input can be information from surveys and PPI independent research, and output may be information that defines customer critical to quality (“CTQ”) parameters for products of interest. PPIs can also utilize the inventive computer system and its portals to define test plans that includes one or more product tests that will evaluate products of interest against customer CTQ parameters, and to construct and distribute data collection templates for use by test laboratories.

Test laboratories may use the inventive computer system and its portals to retrieve test plans and data collection templates. Test laboratories may conduct product tests for one or more products and can use the inventive computer system and its portals to report test status and raw test data, wherein the test data for one or more products may be stored within the inventive computer system in a consolidated manner and both test data and test status may be visually displayed utilizing one or more portals. Alternatively, PPIs may conduct product testing and utilize the inventive computer system and its portals in the same manner as test laboratories.

PPIs may utilize the inventive computer system and its portals to retrieve raw test data, and may then analyze and summarize the raw test data. PPIs may determine relative index performance scores (“RIPS”) for vendor products by applying weighting factors and other calculations to the raw test data with the inventive computer system. Weighting factors may represent customer CTQ parameters rather than product attributes or compliance to safety standards. Other calculations supported by the inventive computer system include, but are not limited to, indexing test results for each product against the average (or another statistical measure) of all products thereby normalizing results on a zero-to-one basis. PPIs may utilize the inventive computer system and its portals to construct scorecards that textually and graphically display information for product CTQ parameters.

Clients (i.e. product vendors who sell products from a range of different product vendors) may use the inventive computer system and its portals to view and modify scorecards for use in comparing product activities wherein one or more products and/or one or more tests may be excluded from scorecards, weighting factors, and the unit of measure. The means of the summary data calculations may be changed, while additional data may be added that is relevant to the analysis (e.g., vendor cost data) and relative comparisons may be dynamically calculated and graphically displayed with the inventive computer system.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a block diagram of a computer system that provides the exemplary operating environment for the present invention.

FIG. 1B illustrates a functional block diagram of main components for the host computer of FIG. 1A.

FIG. 2 is a flow diagram that illustrates high-level sequencing of individual process flow steps that can be implemented using the present invention.

FIG. 3A is a logic flow diagram that illustrates an exemplary method for determining critical to quality (“CTQ”) parameters for a product.

FIG. 3B is a graphical representation of an exemplary graphical user interface for a customer portal.

FIG. 3C is a graphical representation of an exemplary graphical user interface for a vendor portal.

FIG. 3D is a graphical representation of an exemplary graphical user interface for a test lab portal.

FIG. 3E is another graphical representation of an exemplary graphical user interface for a test lab portal.

FIG. 4 is a logic flow diagram that illustrates a routine or submethod of FIG. 2 for determining of product test plans and data collection templates.

FIG. 5 is a logic flow diagram of a routine or submethod of FIG. 2 that illustrates how product testing is conducted and monitored.

FIG. 6A is a logic flow diagram of a routine or submethod of FIG. 2 that illustrates a determination of relative index performance scores and construction of product scorecards.

FIG. 6B is a logic flow diagram of a routine or submethod of FIG. 6A that illustrates how to normalize test data.

FIG. 7 is a logic flow diagram of a routine or submethod of FIG. 2 that illustrates modification of product scorecards.

FIG. 8 illustrates an exemplary product scorecard data table constructed according to the routine of FIG. 7.

FIG. 9A is an exemplary graphical user interface comprising a graphical representation of an overall relative index performance scores type scorecard.

FIG. 9B illustrates an exemplary product scorecard data table constructed according to the routine of FIG. 6A.

FIG. 9C illustrates an exemplary product scorecard data table constructed according to the routine of FIG. 6B.

FIG. 9D is an exemplary graphical user interface comprising a graphical representation of an overall relative index performance scores type scorecard in which data has been normalized.

FIG. 10 is an exemplary graphical user interface comprising an arrangement of a single page “at a glance” scorecard.

FIG. 11 is a graphical user interface comprising an exemplary product scorecard data table of FIG. 8 enabled for editing.

FIG. 12 is a graphical user interface of the scorecard data table of FIG. 8 with additional menu features displayed.

FIG. 13 is a graphical user interface comprising a graphical representation of the relative index performance scorecard of FIG. 9 enabled for editing.

FIG. 14 is a graphical user interface comprising graphical representation of the relative index performance scorecard of FIG. 9 modified according to the routine of FIG. 7.

FIG. 15 is a graphical user interface comprising an exemplary graphical representation of product cost to the consumer vs. overall relative index performance scores—scorecard.

FIG. 16 is a graphical user interface comprising a graphical representation of product cost to the consumer vs. overall relative index performance scores—scorecard enabled for editing.

FIG. 17 is a graphical user interface for the graphical representation of FIG. 16 modified according to the routine of FIG. 8.

FIG. 18 is a graphical user interface that comprises two scorecards that compare product scores for two different types of products.

FIG. 19 is an exemplary graphical display of a first window comprising a first frame of video of a product test.

FIG. 20 is an exemplary graphical display of a second window comprising a second frame of video of a product test.

### DETAILED DESCRIPTION OF EMBODIMENTS OF THE INVENTION

The word “exemplary” is used herein to mean “serving as an example, instance, or illustration.” Any aspect described herein as “exemplary” is not necessarily to be construed as preferred or advantageous over other aspects.

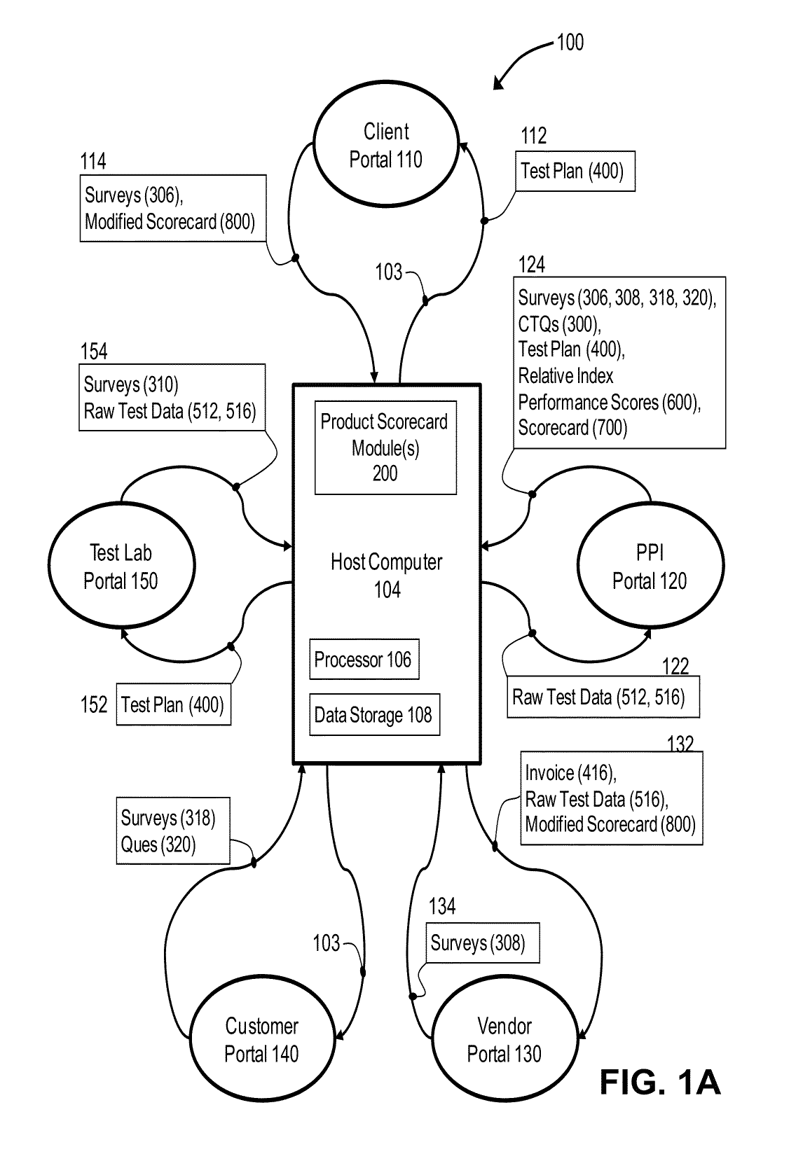

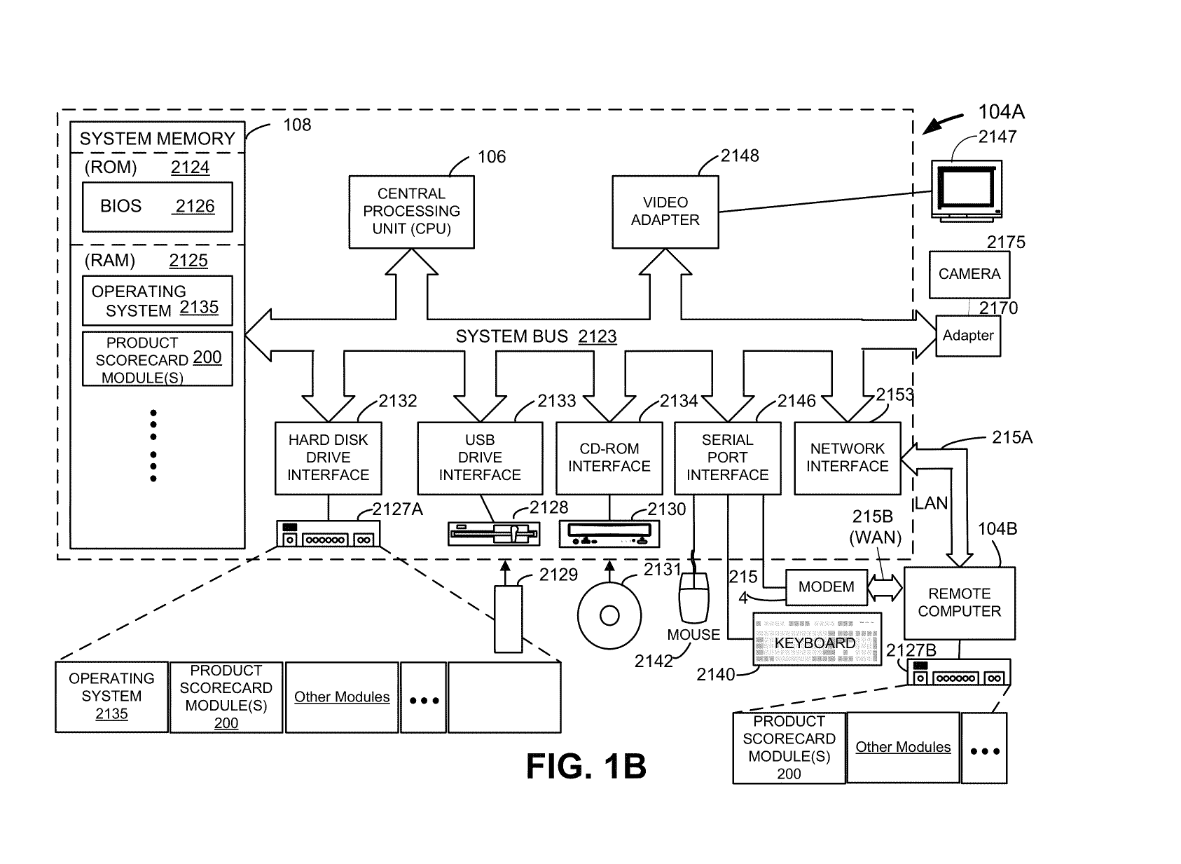

Referring now to the drawings, in which like numeral represent like elements throughout the several figures, aspects of the present invention will be described. Referring to FIG. 1A, computer system 100 may include a host computer 104 that provides a client portal 110 (for product retailers who sell products from a range of different product vendors), a product performance intermediary (“PPI”) portal 120 (for product testing coordinators hired by clients/retailers), a vendor portal 130 (for product manufacturers and/or product distributors), a customer portal 140 (for direct consumers of products) and/or a test lab portal 150 (for product testing labs). Each portal may comprise client software operating in an Internet Browser that communicates with the host computer 104 wherein information and data are sent and received as illustrated in FIG. 1A. For example, information and data 122 may be communicated from the host computer 104 to the product performance intermediary (“PPI”) portal 120 which may include raw test data 512 and 516.

In one exemplary embodiment of the invention, the host computer 104 and portals 110, 120, 130, 140 and/or 150 may be executed/supported by a single computer unit such as a personal computer (PC) 104 that includes a visual display 2147 such as a monitor and operator input devices that can include a keyboard 2140, a mouse 2142 or other devices. It is understood that host computer 104 can include a processor 106 and data storage 108. The processor 106 may execute computer code, such as machine code, associated with the inventive system 100.

The computer code/software of the inventive system 100 may comprise one or more product scorecard modules 200 as will be described in further detail below. While the invention may comprise computer code/software, the invention may also be hard-coded in hardware and/or a combination of hardware and software as understood by one of ordinary skill in the art. Many of the steps described below will be part of the product scorecard modules 200 referenced in FIG. 1.

Data storage may include digital, optical, and/or magnetic computer memory components as are commonly known to one of ordinary skill in the art. In the exemplary embodiment of FIG. 1A, each portal may be accessed separately and one-at-a-time by individual users when they access the computer system 100 over a distributed computer network 215 (See FIG. 1B), that may include a local area network (“LAN”) 215A, wide area network (“WAN”) 215B, and/or the Internet. Many of the system elements illustrated in FIG. 1A are coupled via communications links 103 over the distributed computer network 215.

The communication links 103 illustrated in FIG. 1A may comprise wired or wireless couplings or links. Wireless links include, but are not limited to, radio-frequency (“RF”) links, infrared links, acoustic links, and other wireless mediums. The computer network 215 (See FIG. 1B) may comprise a wide area network (“WAN”) 215B, a local area network (“LAN”) 215A, the Internet, a Public Switched Telephony Network (“PSTN”), a paging network, or a combination thereof. The computer network 215 may be established by broadcast RF transceiver towers (not illustrated). However, one of ordinary skill in the art recognizes that other types of communication devices besides broadcast RF transceiver towers are included within the scope of this disclosure for establishing the computer network 215.

This means that the host computer 104 and portals 110, 120, 130, 140 and/or 150 may be supported by a local computer network. In this exemplary embodiment, the host computer 104 and individual portals may reside on separate computers 104 wherein the host computer 104 and other computers 104 communicate using a networking device such as a wired or wireless router. It is understood that the host computer 104 and individual computers 104 each may have a processor 106, data storage 108, a visual display 2147 and operator input devices. In this exemplary embodiment, each portal may be accessed separately or simultaneously by individual users when operating the individual computers 104. It is understood to one of ordinary skill in the art that any or all of the individual computers 104 may act as both a portal and as host computer 104 for the inventive system 100.

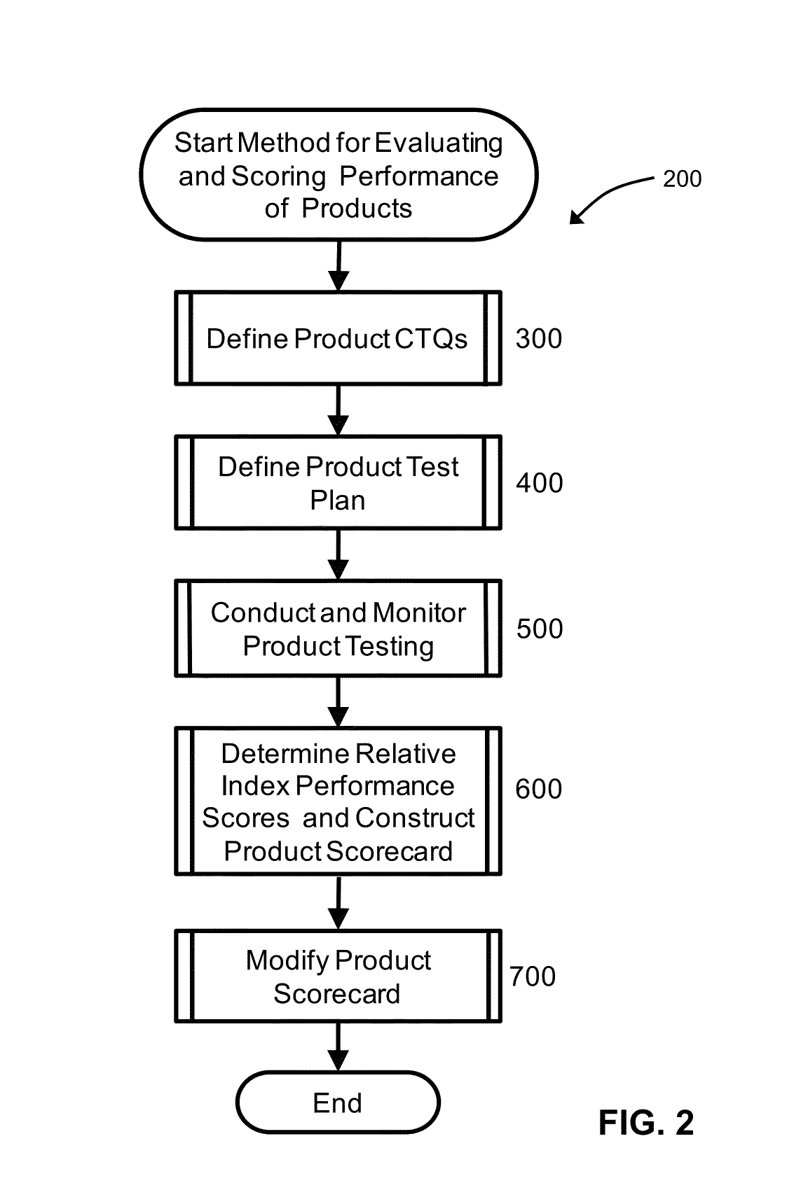

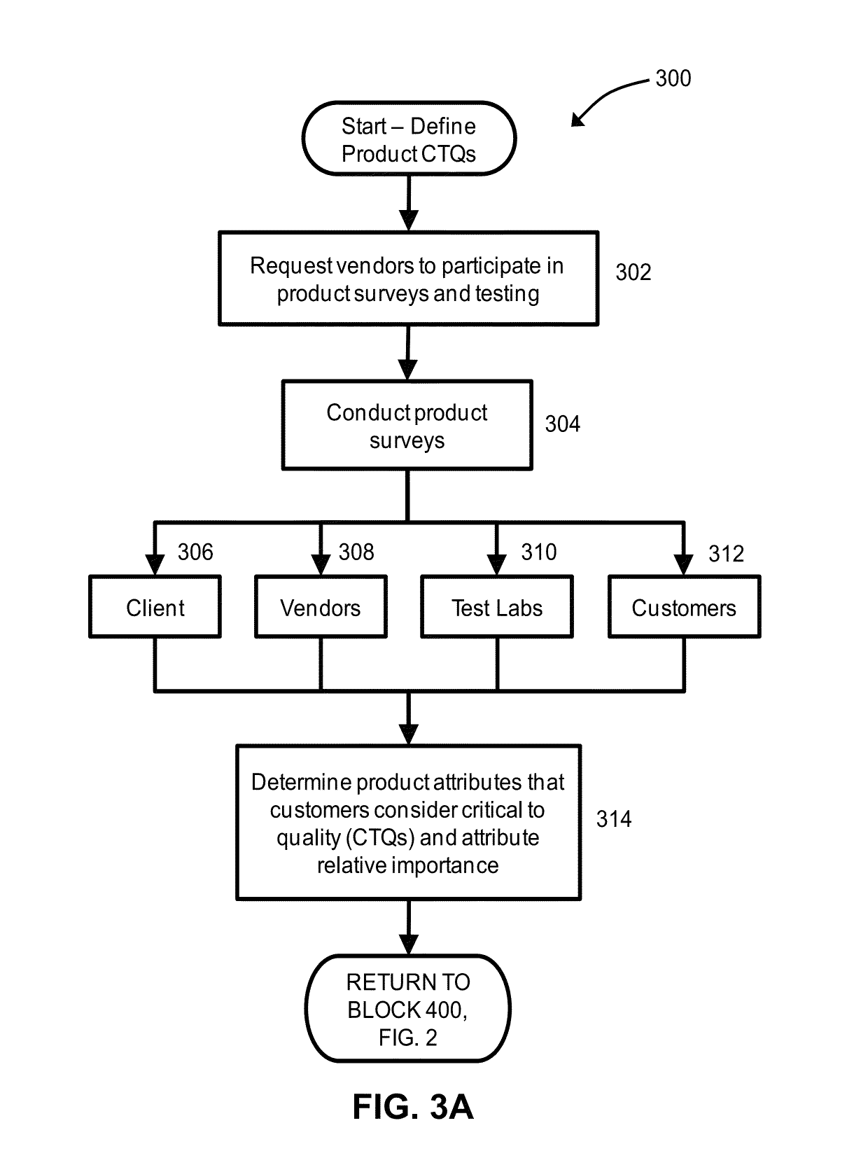

In an exemplary embodiment, the inventive computer system 100 may be implemented on a computer network server 104 such as can commonly be used for internet website hosting. In such an exemplary embodiment, the host computer 104 may comprise a computer network server with associated processor 106 and data storage 108. The host computer 104 may run one or more product scorecard modules 200. The product scorecard modules 200 may comprise software or hardware or both. Further details of the product scorecard modules will be described below in connection with the process flow of FIG. 2.

The portals on each client device that include the client portal 110, the product performance intermediary (“PPI”) portal 120, the vendor portal 130, the customer portable 140, and test lab portal 150, may comprise various hardware and/or software devices that can communicate with the host computer 104 using wired and/or wireless communications. For example, portable computing devices that may support each portal, may include, but are not limited, to a desktop computer, a notebook computer, a netbook computer, a personal digital assistant (PDA), a tablet (e.g., iPad), a cellular phone and the like. These hardware devices can communicate with the host computer 104 via the internet 215 using wired, WiFi, WiMAX, cellular multihop networks and the like.

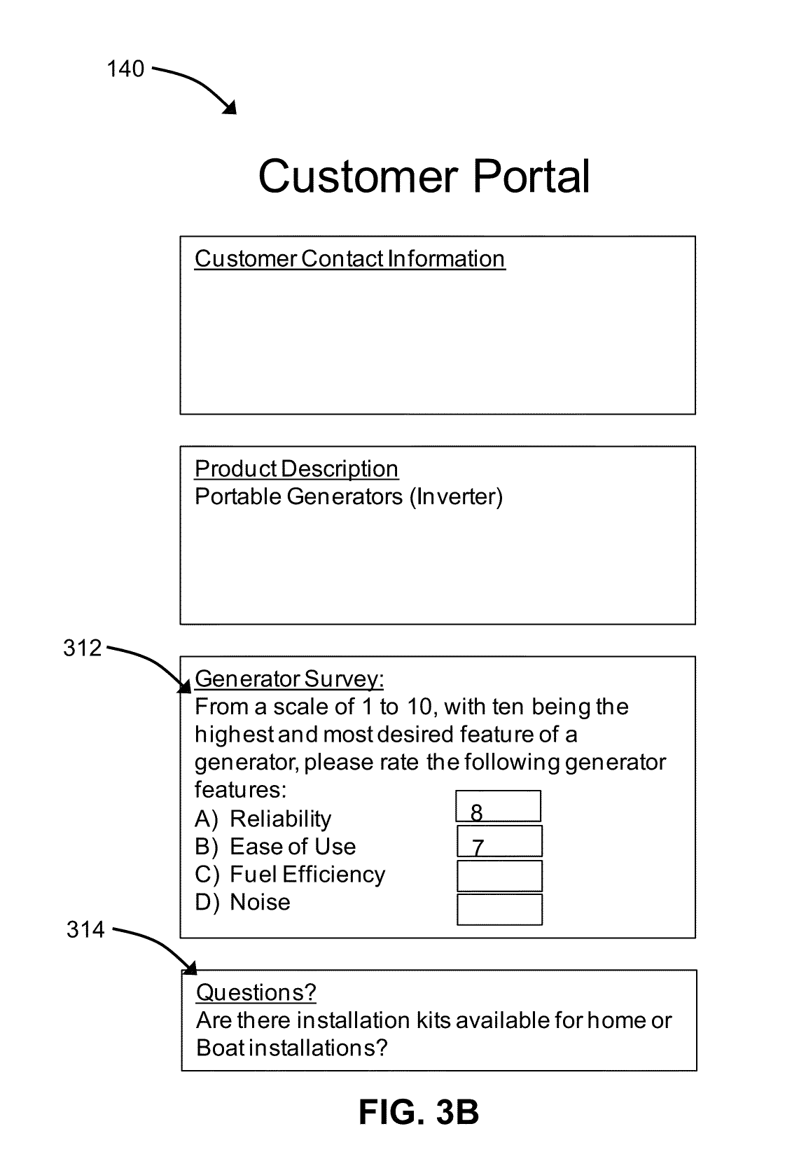

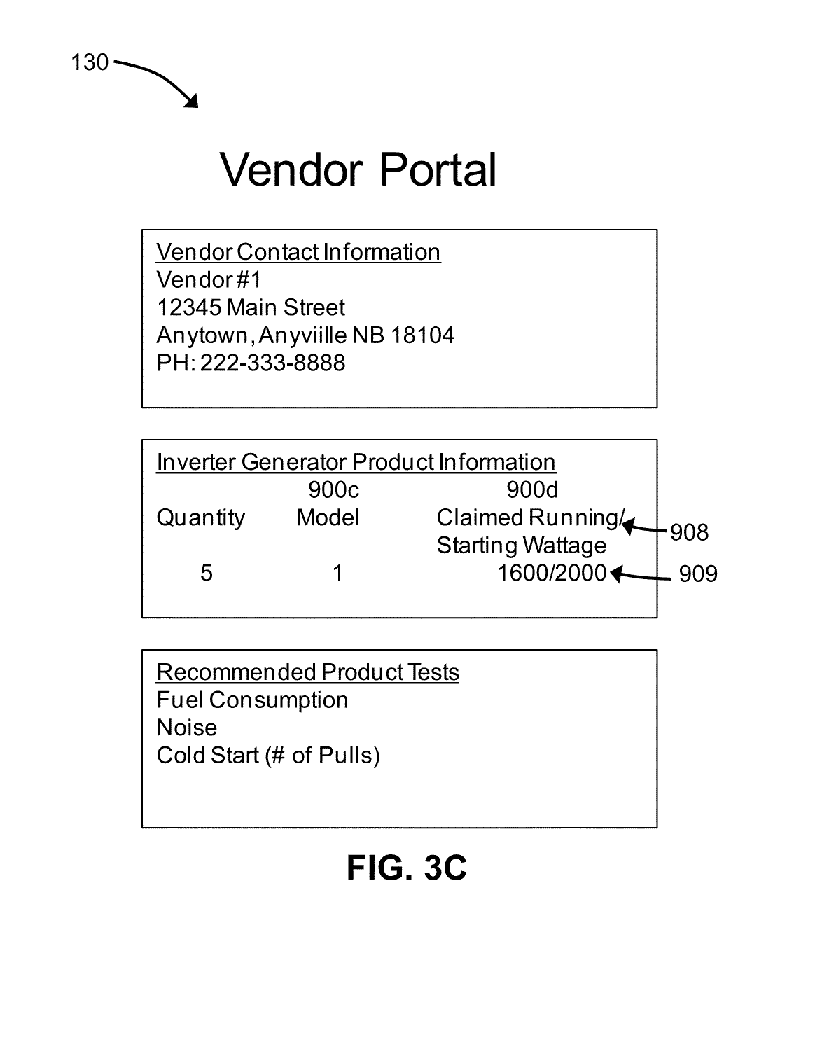

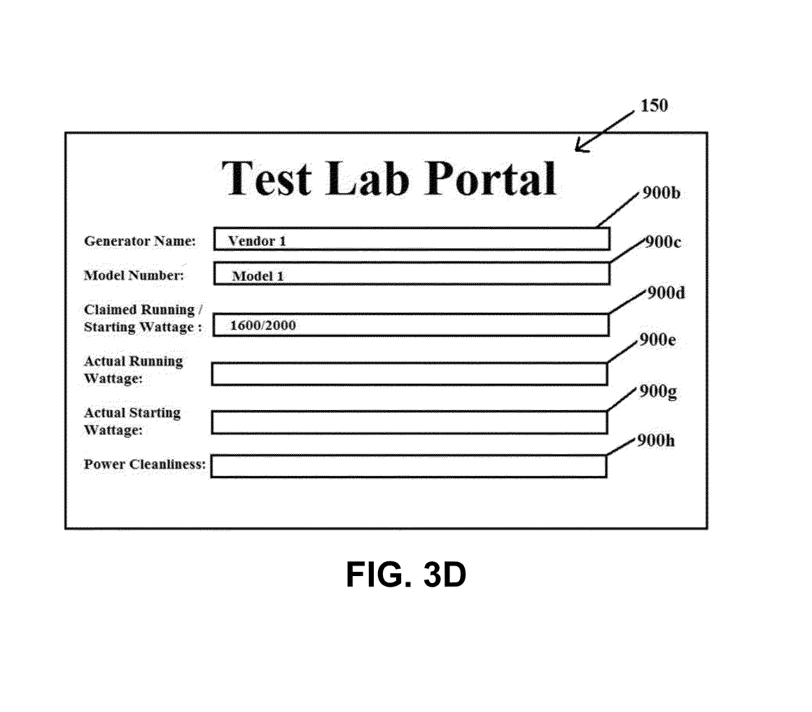

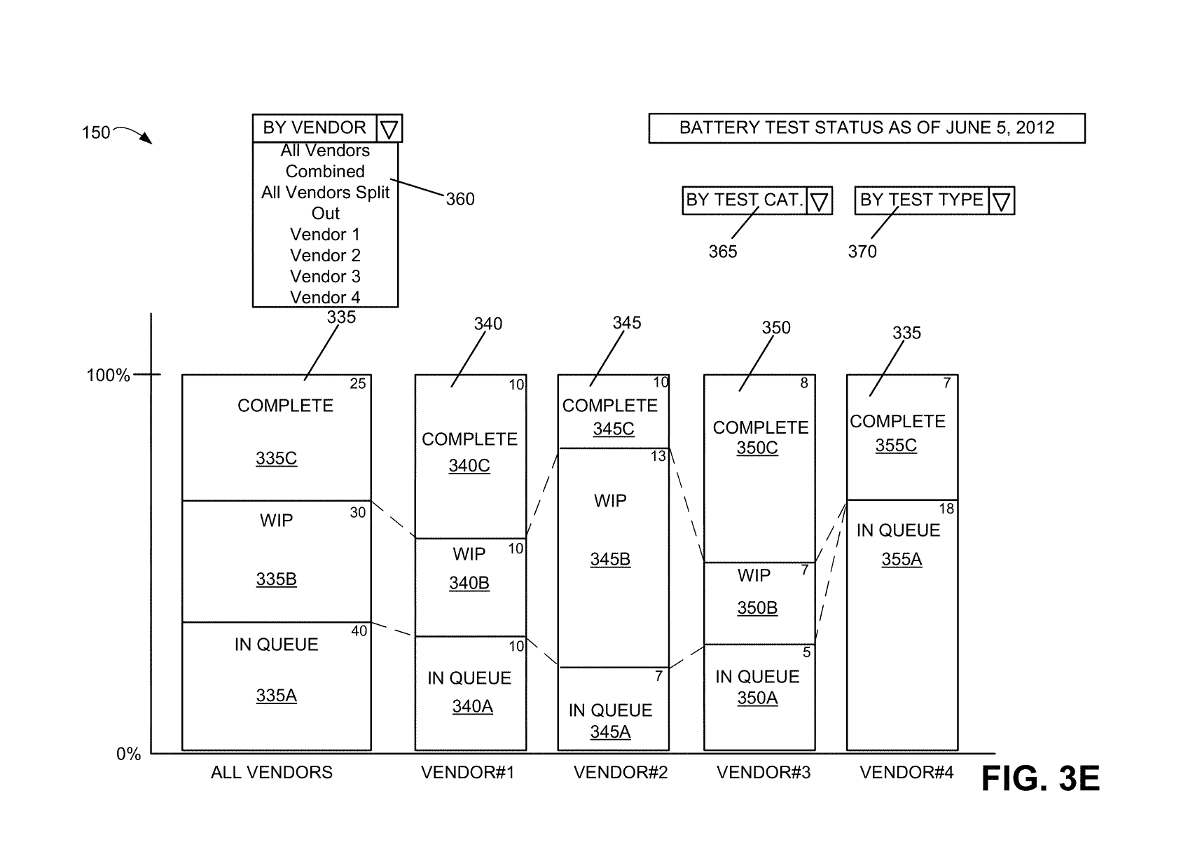

Between the client portal 110 and the host computer 104, exemplary data that may be exchanged includes, but is not limited to, surveys 306; modified scorecards 800; and test plan data 400. The host computer 104 and the product performance intermediary (“PPI”) portal 120 may exchange data that includes, but is not limited to, survey data 306, 308, 310, 318; CTQs 300; test plan data 400; relative indexes; performance scores 600; scorecard data 700; and raw test data 512, 516. The host computer 104 and the vendor portal 130 may exchange data that includes, but is not limited to, survey data 308. Between the host computer 104 and the customer portal 140, data that may be exchanged includes, but is not limited to, survey data 318 and queue data 320. Between the test lab portal 150 and the host computer 104, data that may be exchanged includes, but is not limited to, test plan data 400, survey data 310, and raw test data 512, 516. Further details of this data 300, 306, 308, 310, 318, 320, 400, 512, 516, 600, 700, and 800 will be described below in connection with FIGS. 3A, 3B, and 4-8.

Referring now to FIG. 1B, this figure is a functional block diagram of host computer 104A that can be used in the system 100 and method for evaluating, comparing, scoring and valuing a product according to an exemplary embodiment of the invention. The exemplary operating environment for the system 100 includes a general-purpose computing device in the form of a conventional computer 104.

Generally, the computer 104A includes a processing unit 106, a system memory or storage 108, and a system bus 2123 that couples various system components including the system memory 108 to the processing unit 106.

The system bus 2123 may be any of several types of bus structures including a memory bus or memory controller, a peripheral bus, and a local bus using any of a variety of bus architectures. The system memory includes a read-only memory (“ROM”) 2124 and a random access memory (“RAM”) 2125. A basic input/output system (“BIOS”) 2126, containing the basic routines that help to transfer information between elements within computer 104A, such as during start-up, is stored in ROM 2124.

The computer 104A can include a hard disk drive 2127A for reading from and writing to a hard disk, not shown, a universal serial bus (“USB”) drive 2128 for reading from or writing to a removable USB flash memory unit 2129, and an optical disk drive 2130 for reading from or writing to a removable optical disk 2131 such as a CD-ROM or other optical media. Hard disk drive 2127A, USB drive 2128, and optical disk drive 2130 are connected to system bus 2123 by a hard disk drive interface 2132, a USB drive interface 2133, and an optical disk drive interface 2134, respectively.

Although the exemplary environment described herein employs hard disk 2127A, USB drive 2129, and removable optical disk 2131, it should be appreciated by those skilled in the art that other types of computer readable media which can store data that is accessible by a computer, such as magnetic cassettes, digital video disks (“DVDs”), Bernoulli cartridges, RAMs, ROMs, and the like, may also be used in the exemplary operating environment without departing from the scope of the invention. Such uses of other forms of computer readable media besides the hardware illustrated will be used in computer networked (i.e.—Internet) connected devices.

The drives and their associated computer readable media illustrated in FIG. 1B provide nonvolatile storage of computer-executable instructions, data structures, program modules, and other data for computer 104A. A number of program modules may be stored on hard disk 2127, USB drive 2129, optical disk 2131, ROM 2124, or RAM 2125, including, but not limited to, an operating system 2135 and the product scorecard module(s) 200 of FIG. 1A. Program modules include routines, sub-routines, programs, objects, components, data structures, etc., which perform particular tasks or implement particular abstract data types.

A user may enter commands and information into computer 104A through input devices, such as a keyboard 2140 and a pointing device 2142. Pointing devices may include a mouse, a trackball, and an electronic pen that can be used in conjunction with an electronic tablet. Other input devices (not shown) may include a microphone, joystick, game pad, satellite dish, scanner, or the like. These and other input devices are often connected to processing unit 106 through a serial port interface 2146 that is coupled to the system bus 2123, but may be connected by other interfaces, such as a parallel port, game port, a universal serial bus (“USB”), Wi-Fi or the like.

The display 2147 may also be connected to system bus 2123 via an interface, such as a video adapter 2148. As noted above, the display 2147 can comprise any type of display devices such as a liquid crystal display (“LCD”), a plasma display, an organic light-emitting diode (“OLED”) display, and a cathode ray tube (“CRT”) display.

A camera 2175 may also be connected to system bus 2123 via an interface, such as an adapter 2170. The camera 2175 may comprise a video camera such as a webcam. The camera 2175 may be a CCD (charge-coupled device) camera or a CMOS (complementary metal-oxide-semiconductor) camera. In addition to the monitor 2147 and camera 2175, the computer 104A may include other peripheral output devices (not shown), such as speakers and printers.

The computer 104A may operate in a networked environment using logical connections to one or more remote computers 104B. These remote computers 104 may comprise the Retailer Portal 110, Test Lab Portal 150, Customer Portal 140, Vendor Portal 130 and product performance intermediary (“PPI”) Portal 120 of FIG. 1A in which these portals comprise client software comprising web browser software that accesses the main product scorecard module 200 running on computer 104A. In such an exemplary scenario, the computer 104A may comprise one or more server computers coupled together across a computer network.

Each remote computer 104B may be another personal computer, a computer server, a mobile phone, a router, a network PC, a peer device, tablet (e.g., iPad) or other common network node. While the remote computer 104B typically includes many or all of the elements described above relative to the main computer 104A, only a memory storage device 127B has been illustrated in this FIG. 1B for brevity. The logical connections depicted in FIG. 1B include a local area network (LAN) 215A and a wide area network (WAN) 215B. Such networking environments are commonplace in offices, enterprise-wide computer networks, intranets, and the Internet.

When used in a LAN networking environment, the computer 104A is often connected to the local area network 215A through a network interface or adapter 2153. When used in a WAN networking environment, the computer 104A typically includes a modem 2154 or other means for establishing communications over WAN 215B, such as the Internet. Modem 2154, which may be internal or external, is connected to system bus 2123 via serial port interface 2146. In a networked environment, program modules depicted relative to the main computer 104A, or portions thereof, may be stored in the remote memory storage device 2127B of the remote computer 104B. It will be appreciated that the network connections shown are exemplary and other means of establishing a communications link between the computers 104 may be used.

Moreover, those skilled in the art will appreciate that the present invention may be implemented in other computer system configurations, including hand-held devices, multiprocessor systems, microprocessor based or programmable consumer electronics, network personal computers, minicomputers, tablets (e.g., iPad) mainframe computers, and the like. The inventive system 100 may also be practiced in distributed computing environments, where tasks are performed by remote processing devices that are linked through a communications network. In a distributed computing environment, program modules may be located in both local and remote memory storage devices.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Referring now to FIG. 2, individual steps/routines of an overall product evaluation, valuation and scoring (“PEVS”) process flow 200 are illustrated. Specifically, FIG. 2 is a flow diagram that illustrates high-level sequencing of individual process flow steps that can be implemented using the present inventive system 100.

The process flow 200 generally corresponds with the machine instructions that embody the product scorecard modules that are executed by the host computer 104. Process flow and the product scorecard modules 200 will be used interchangeably throughout this document to describe the steps/routines executed by the server 104 and/or anyone of the portals of FIG. 1A.

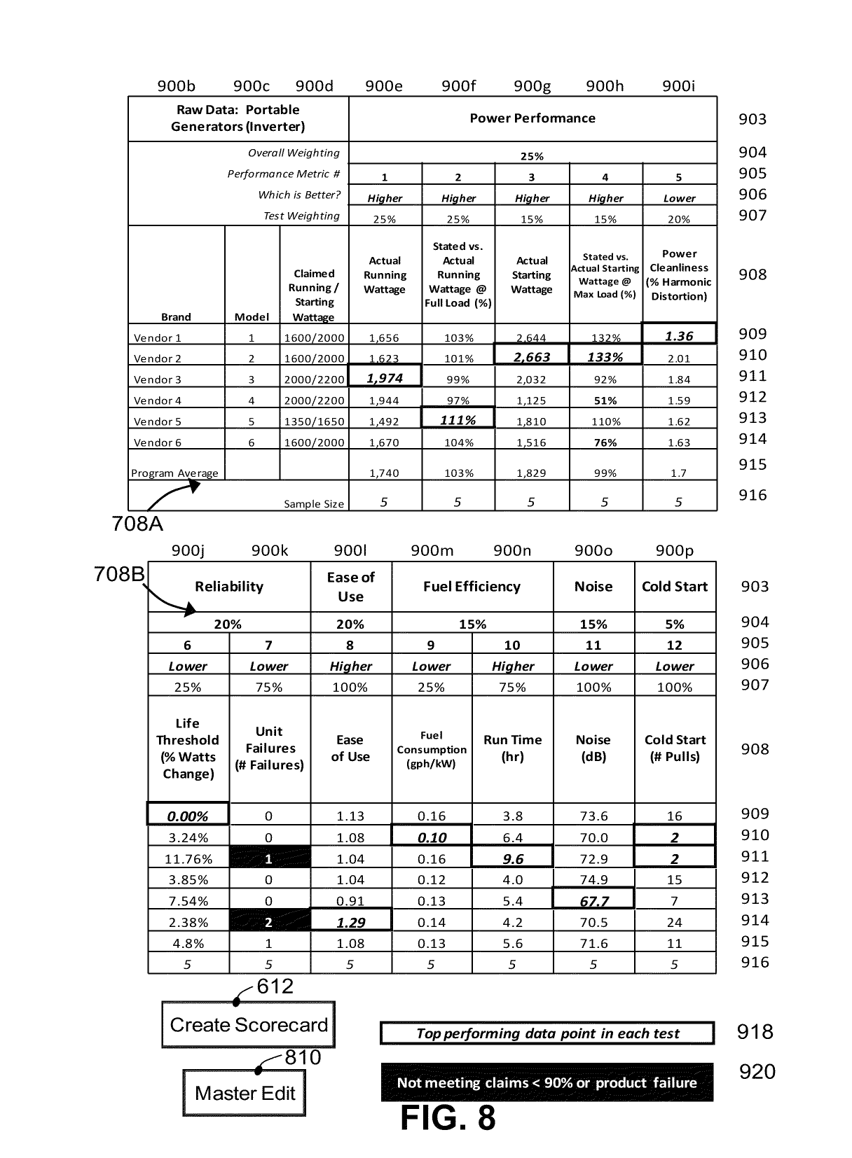

The overall product evaluation, valuation and scoring (“PEVS”) process flow 200 (that also embodies the product scorecard modules 200 of FIG. 1) has several steps/routines that include, but are not limited to, defining product critical to quality (“CTQs”) parameters routine 300, defining a product test plan routine 400, conducting and monitoring product testing routine 500, determining relative index performance scores (“RIPS”) and constructing product scorecards routine 600, and modifying a product scorecard routine 700. It is to be understood that each routine or submethod may be practiced individually. Each of the routines listed may comprise one or more steps and/or additional routines/submethods as understood by one of ordinary skill in the art. Detailed descriptions of routines 300 to 700 are provided below and illustrated FIGS. 3 and 8.

### Routine 300: Defining Product Critical to Quality (“Ctq”) Parameters

Referring now to FIG. 3A, details for the product CTQ definition routine/submethod 300 are now described. Specifically, FIG. 3A is a logic flow diagram that illustrates an exemplary submethod 300 for determining critical to quality (“CTQ”) parameters for a product. Block 302 is the first step of routine 300. The product CTQ definition routine/submethod 300 may include requesting vendors, via messages over a computer network 215, to participate in product surveys and testing in block 302. In block 304, these product surveys may be conducted on line. Steps 302 and 304 may be conducted by product performance intermediaries (“PPIs”) utilizing the computer system 100 and portals of the present invention.

For example, PPIs can utilize the computer system 100 and portals to send an electronic mail message (e-mail) or instant message to any or all of clients, vendors, test labs and/or customers requesting participation in surveys for a particular product. Client responses 306, vendor responses 308, test lab responses 310 and customer responses 312 may be received by the computer system 100 from portals including 110, 120, 130, 140 and/or 150. It is understood that block 304 may include more than one electronic communication between a PPI and a retailer, vendor, test lab and/or customer, and possibly be supplemented by live meetings or telephone exchanges.

Next, in block 314, product attributes that customers may consider critical to quality (“CTQ”) may be determined and a relative importance to each CTQ parameter may be assigned. In this block 314, the host computer 104 may assist an operator in organizing and collecting the data received from the responses 306-312 described above. The CTQ parameters may be determined automatically from the host computer 104 and/or in combination with an operator reviewing the data collected and stored by the host computer 104. The operator may create a set of rules that assist the host computer 104 in refining the CTQ parameters collected. These rules may also provide for/assist with assigning a relative importance to each CTQ parameter determined for a specific product. The process then returns to routine block 400 of FIG. 2.

FIG. 3B is a graphical representation of an exemplary graphical user interface for a customer portal 140. The customer portal 140 may allow a customer or consumer who purchases products from retailers to provide responses 312 to questions from surveys generated by the retailer and/or PPIs. The portal 140 may also allow customers to provide their own questions 314 about products which can be reviewed by the retailers and/or PPIs.

PPIs and/or retailers can review the responses 318 from the surveys and the questions 320 from the customers to determine product attributes that customers perceive to be critical to quality (“CTQ”) parameters. CTQ parameters may comprise a single measured product attribute but in many cases are not. For example, a client may be interested in comparing portable gasoline-powered electric generators (inverter generators) from several vendors. A first vendor may emphasize its belief that customers care most about lower harmonic distortion and higher reliability CTQ parameters when comparing similar products. A second vendor may emphasize superior ease of use CTQ parameter as most important to a customer.

A third vendor may suggest superior fuel efficiency as the most vital CTQ parameter. A fourth vendor may suggest lower noise as the best CTQ parameter. There can be a wide disparity in the product attributes that vendors believe customers consider as important CTQ parameters for similar products. Each of these vendors might respond to the PPI survey and separately rate harmonic distortion and reliability, ease of use, fuel efficiency and low noise as having highest importance (respectively).

Vendors may use the inventive computer system 100 and its portals to recommend product tests that they commonly use to test their products. FIG. 3C shows one possible arrangement of a vendor portal 130. Specifically, FIG. 3C is a graphical representation of an exemplary graphical user interface for a vendor portal 130.

The vendor portal 130 may comprise a graphical user interface that allows product vendors to provide product information 908, 909 that may be results from the vendor's prior testing of its own products. In the exemplary embodiment illustrated in FIG. 3C, the product information comprises the claimed running wattage 908 of an electric generator and the starting wattage of the electric generator.

The portal 130 may also allow product vendors to provide recommendations of product tests. The vendor portal 130 may be also used to collect vendor specific SKU info for test programs and to generate an invoice. Additionally, a modified version of a main scorecard (i.e., only the vendor's product data present) may be used to show the vendor their summary output. Further details about scorecards will be described below.

PPI surveys might reveal that customers consider the product information 908, 909 supplied by the vendor as CTQ parameters. But it may be determined that customers also desire additional CTQ parameters for electric generators that measures when an electric generator that “cold” starts with only one or two pulls on the starter cord, and a generator that can be overloaded for short periods of time as compared to its rated wattage.

The PPI may determine that a combination of the following may comprise customer CTQ parameters for inverter generators wherein these attributes are listed in relative order of importance (with the first parameter being the most important and the last parameter being the lowest of importance): Power Performance, Reliability, Ease of Use, Fuel Efficiency, Noise and Cold Start. These CTQ parameters may be communicated to the computer system 100 over a computer network 215 by the PPI utilizing the PPI portal 120.

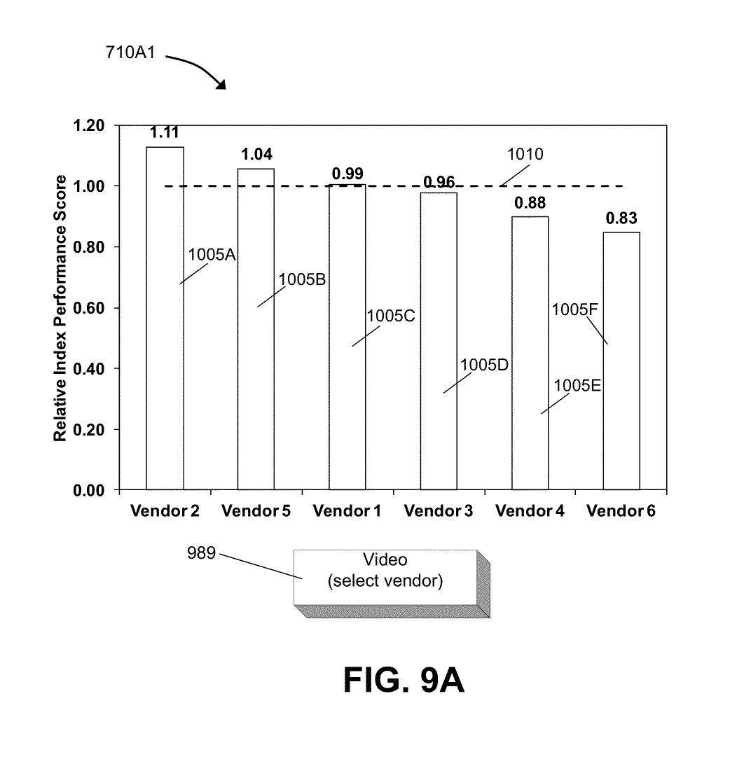

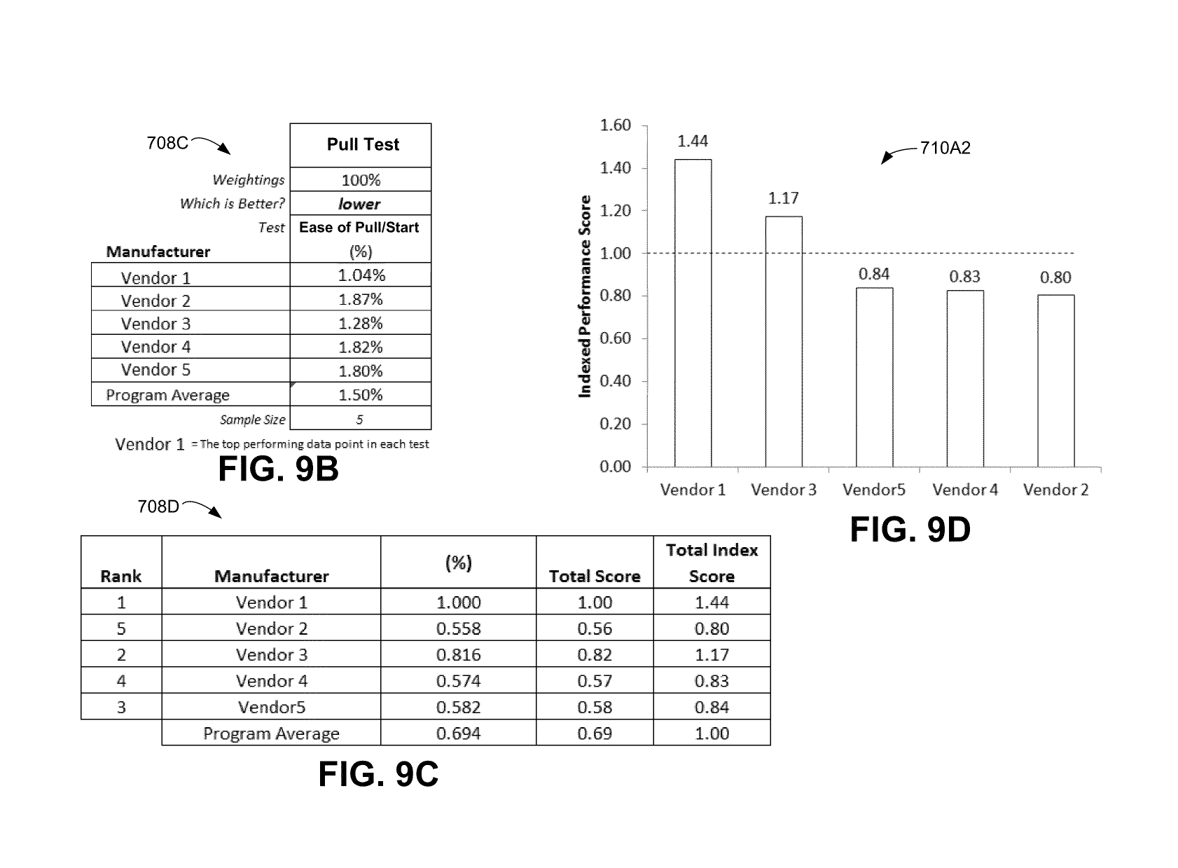

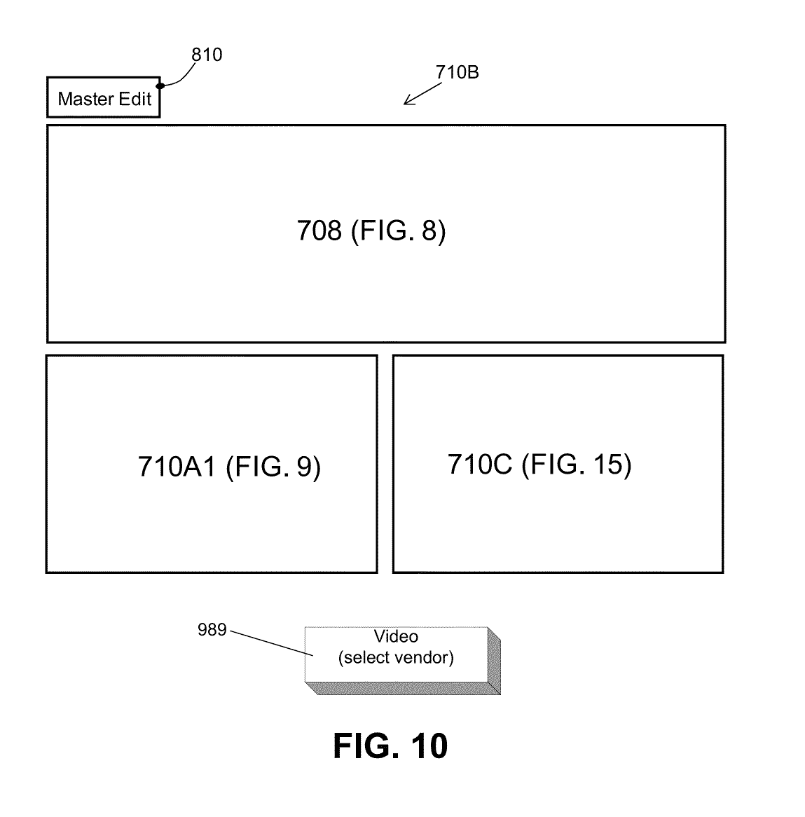

FIG. 3D shows one possible arrangement of a test lab portal 150. Specifically, FIG. 3D is a graphical representation of an exemplary graphical user interface for a test lab portal 150. Test lab portal 150, like the other portals, may comprise a graphical user interface (“GUI”) that allows each test lab to enter information about its testing of particular products. For example, each test lab may enter data such as product vendor name 900b, product model number 900c, and various test result data such as, in the example of inverter generator products, claimed running startage wattage 900d, actual running wattage 900e, actual starting wattage 900g, and power cleanliness 900h. Test result data 900d-900h will be described in further detail below and is illustrated in FIGS. 9-11. PPIs can utilize PPI portal 120 to retrieve and visually display test results such as presented in FIGS. 9, 10 and 11.

FIG. 3E provides another graphical representation of a test lab portal 150 that may be accessed by retailers and/or PPIs for managing tests across various different products and test labs. Specifically, FIG. 3E is another graphical representation of an exemplary graphical user interface for a test lab portal 150. The test lab portal 150 may display progress of the testing of products in various graphical formats such as bar charts, pie charts, etc. In the exemplary embodiment illustrated in FIG. 3E, test progress is reflected using five bar charts. The first bar chart 335 may track testing across a total of four product vendors/manufacturers: product vendor #1, product vendor #2, product vendor #3, and product vendor #4.

The first bar chart 335 of test lab portal 150 in FIG. 3E reflects that 40% of the tests (335A) are in queue, while 35% are a work-in-progress (“WIP”) (335B), and that 25% of the tests are complete (335C). The second through fifth bar charts 340-355 represent the progress of testing for each particular product vendor. Specifically, the second bar chart 340 reflects ten product tests in queue (340A), ten product tests work-in-progress (“WIP”) 340B, and ten product tests completed (340C). The total number of tests being tracked by this second bar chart 340 is thirty.

The third bar chart 345 reflects seven product tests in queue (345A), thirteen product tests work-in-progress (“WIP”) 345B, and ten product tests completed (345C). The total number of tests being tracked by this third bar chart 345 is thirty. The fourth bar chart 350 reflects five product tests in queue (350A), seven product tests work-in-progress (“WIP”) 350B, and 8 product tests completed (350C). The total number of tests being tracked by this fourth bar chart 350 is twenty. The fifth bar chart 355 reflects eighteen product tests in queue (355A), no (zero) product tests work-in-progress (“WIP”), and two product tests completed (355C). The total number of tests being tracked by this second bar chart 340 is twenty.

This test lab portal 150 may comprise various drop-down menus such as three menus 360, 365, and 370 that allow a retailer and/or PPI to display data in various different and selectable formats. For example, a first drop-down menu 360 may allow a retailer and/or PPI to display a bar chart that is specific to a particular vendor. Options for this drop-down menu may include, but are not limited to, all product vendors combined, all product vendors displayed but listed out into separate bar charts (such as illustrated in FIG. 3E), and selection of individual product vendors like product vendor #1, product vendor #2, product vendor #3, and product vendor #4. Another drop-down menu, like the second menu 365, may allow a retailer and/or PPI to display a bar chart that is specific to particular test categories, etc. Exemplary options for this second menu 365 include, but are not limited to, all test categories combined, all test categories displayed but separate from another by product vendor, and in the example of a product for inverter generators: cycle life test, application life, charge time, and efficiency.

Another drop-down menu, like the third menu 370, may allow a retailer and/or PPI to display a bar chart that is specific to a particular test. Exemplary options for this third menu 370 include, but are not limited to, all tests combined, all tests displayed but separate from another by product vendor, and in the example for a product of an inverter generators: tests specific to application life of the inverter generator.

One of ordinary skill in the art recognizes that alternative graphical user interfaces may be employed without departing from the scope of the inventive system 100. This means that a greater number or a number less than the categories, data, and data types as illustrated in FIG. 3E may be employed without departing from the scope of this disclosure as understood by one of ordinary skill in the art. The inventive system 100 is not limited to the exemplary graphical user interfaces illustrated in the various figures.

### Routine 400: Defining a Product Test Plan

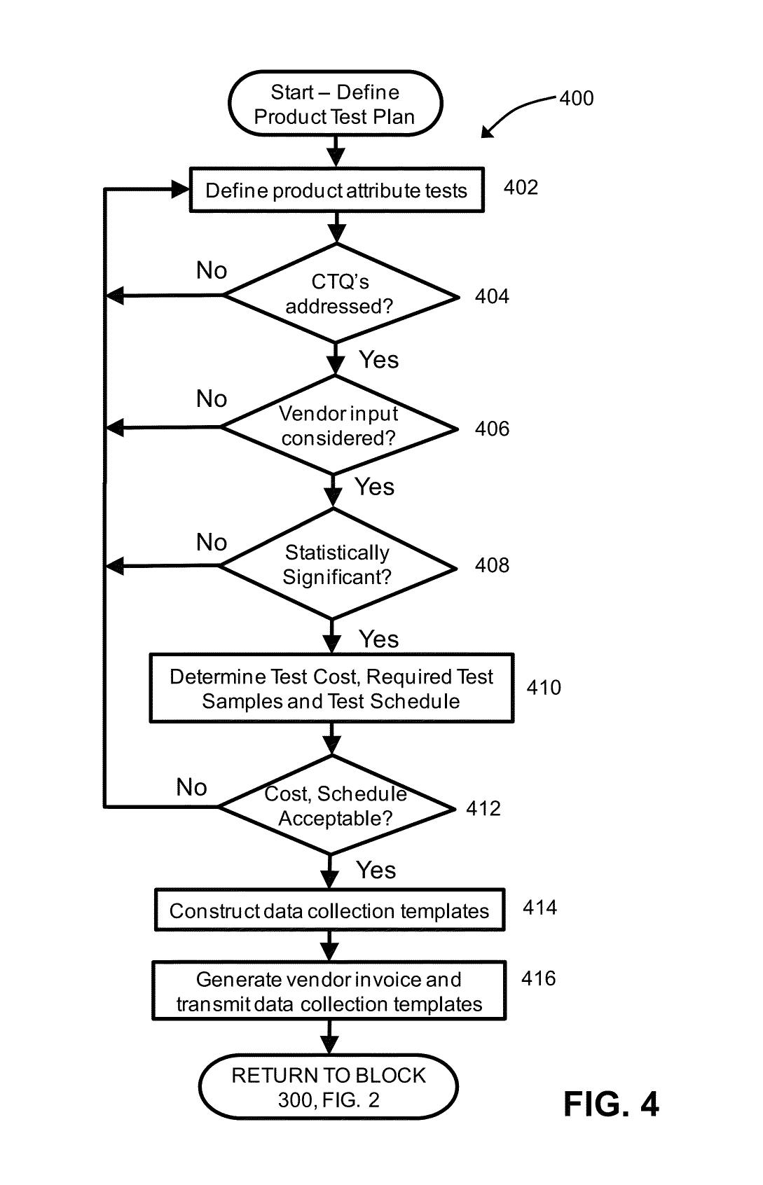

Referring now to FIG. 4, details are now described for defining a product test plan 400 within the PEVS process flow 200 of FIG. 2. Specifically, FIG. 4 is a logic flow diagram that illustrates a routine or submethod 400 of FIG. 2 for determining product test plans and data collection templates. Block 402 is the first step of submethod 400.

Defining a product test plan routine 400 may include defining product attribute tests in block 402. In this block 402, a PPI using PPI portal 120 may assist with defining product test plans for one or more products. The PPI portal 120 may comprise software that includes one or more rules in a database that may assist with defining product test plans.

In decision block 404, it is determined whether individual tests comprising a product test plan will address CTQ parameters uncovered from submethod 300. PPIs and/or the one or more rules may assess industry-standard test methods and existing test methods recommended by vendors; and then determine which individual tests to use as part of the test plan.

If the inquiry to decision block 404 is positive, then the “YES” branch is followed to decision block 406 in which product performance intermediaries (“PPIs”) may determine whether vendor input has been adequately considered in the test plan. In this decision block 406, all individual tests suggested by vendors are usually included in the test plan and reviewed by a PPI. In some cases, PPIs may exclude one or more tests suggested by vendors if those tests evaluate product attributes that are not CTQ parameters or are deemed non-critical by PPIs for other reasons—for example, individual tests that are likely to produce equal results for all products may be excluded.

PPI operators may also include tests in the product test plan that are not suggested by vendors and may even include particular tests that are objected to by one or more vendors. In decision block 408, a PPI may determine if the product test plan will likely provide statistically significant results, wherein statistical significance can be determined using computer system 100 executing certain algorithms known to one of ordinary skill in the art of statistics and product testing. If a PPI and/or computer system 100 determines that the test plan is not statistically significant, then the “NO” branch from decision block 408 may be followed back to block 402 where the test plan may be modified. For example, additional samples can be added to one or more individual tests.

If the inquiry to decision block 408 is positive, then the “YES” branch may be followed to block 410 in which PPIs may communicate with test labs using the computer system 100 and portal 150 to obtain cost quotes and test schedule for conducting the individual product tests. Such cost quotes can include the number of test samples required from each vendor. Once the cost quotes are received, PPIs can review them and determine in decision block 412 whether the cost and schedule are acceptable. This decision block 412 may be performed by an operator and/or by the host computer 104 running a schedule assessment algorithm and/or cost analysis algorithm as understood by one of ordinary skill in the art.

Acceptable cost may include adherence to a budget provided by a client. Acceptable cost may also include adherence to a not-to-exceed cost agreed to by PPIs and vendors, wherein the vendors would be paying for testing of their own products. An acceptable schedule may include adherence to a time schedule provided by a client.

For example, in the aforementioned inverter generator example, an accelerated life test to determine reliability might take several months. If this is unacceptable, a shorter test might be substituted. If costs for certain tests are not acceptable, product performance intermediaries (“PPIs”) may modify or eliminate certain tests and they may also substitute more-expensive tests with less-expensive tests. In such a situation steps 402, 404, 406, and 408 would be repeated. Once decision 408 is satisfied (yes), PPIs may determine test cost, required test samples and the test timing schedule in block 410.

Once block 410 is complete and decision block 412 is satisfied (yes), PPIs in block 414 may construct data collection templates manually and/or automatically with software that may include blank entry points for individual test points associated with individual test samples. PPIs may communicate data collection templates to the computer system 100 utilizing the PPI portal 120. Test labs may retrieve the data collection templates using one or more test lab portals 150 in block 414. Finally, PPIs may also utilize the computer system 100 to generate and transmit vendor invoices according to costs for conducting tests of vendor's products in block 416. PPIs may delay start of testing until vendors have pre-paid for the tests. Submethod or routine 400 ends and the process returns to routine block 500 of FIG. 2.

### Routine 500: Conducting and Monitor Product Testing

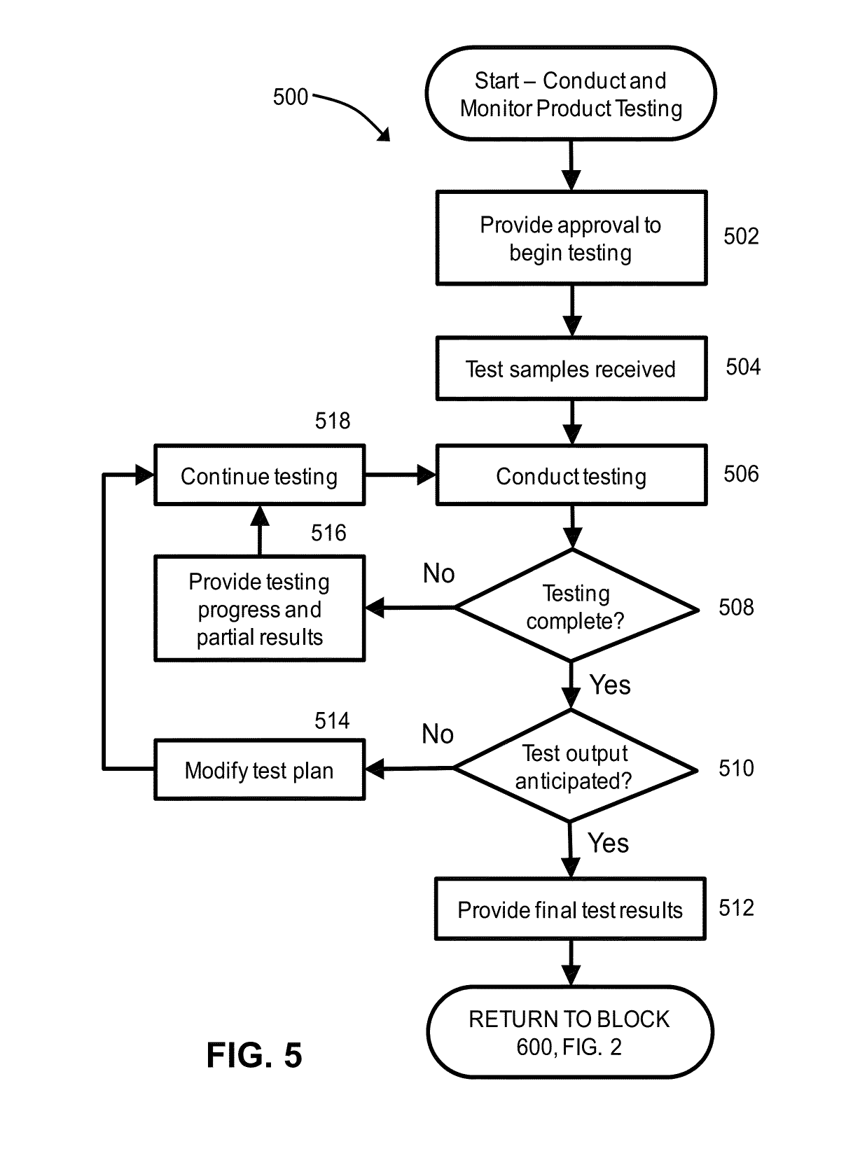

Referring to FIG. 5, details are now described for conducting and monitoring product testing 500 within PEVS process flow 200. Specifically, FIG. 5 is a logic flow diagram of a routine or submethod 500 of FIG. 2 that illustrates how product testing is conducted and monitored. Block 502 is the first step of routine or submethod 500. In block 502, one or more PPIs may provide approval to begin testing. PPIs may utilize the computer system 100 and portals to inform test labs when approval has been granted.

In block 504, test samples may be received by test labs from vendors who transmit the test samples through the test lab portals 150. Alternatively, test samples may be uploaded to the test lab portals 150 from PPIs who may receive the test samples from test labs. Test labs may then conduct tests in block 506. In decision block 508, test labs and/or PPIs may determine if testing of a product has been completed. If not, then in block 516 test labs can utilize the test lab portal 150 to provide testing progress and partial results and then continue testing in block 518. If the inquiry to decision block 508 is positive, then the “YES” branch is followed to decision block 510. In decision block 510, test labs and/or PPIs may determine if complete test output will be available as a result of the one or more tests. If test labs and/or PPIs determine that there may be errors and/or problems with the test output, then the “NO” branch may be followed to block 514.

For example, in the aforementioned inverter generator example, at least some of these products might be expected to complete an accelerated life test with no failures. If all products were to fail the test(s)—thus providing no discrimination between products—a less stringent test may be substituted as determined in block 514. Specifically, in block 514, PPIs may modify test plan 514 and continue testing in block 518. The computer system 100 and portals may be utilized for steps 506, 508, 510, 514, 516 and 518 for communication between PPIs and test labs, to document results and to view results. Upon satisfactory completion of decisions 508 and 510 (yes), test labs in block 512 may utilize the computer system 100 and portals to provide final test results, which are stored in memory in host computer 104. Submethod or routine 500 ends and the process returns to routine block 600 of FIG. 2.

### Routine 600: Determining Relative Index Performance Scores (RIPS) and Constructing Product Score Cards

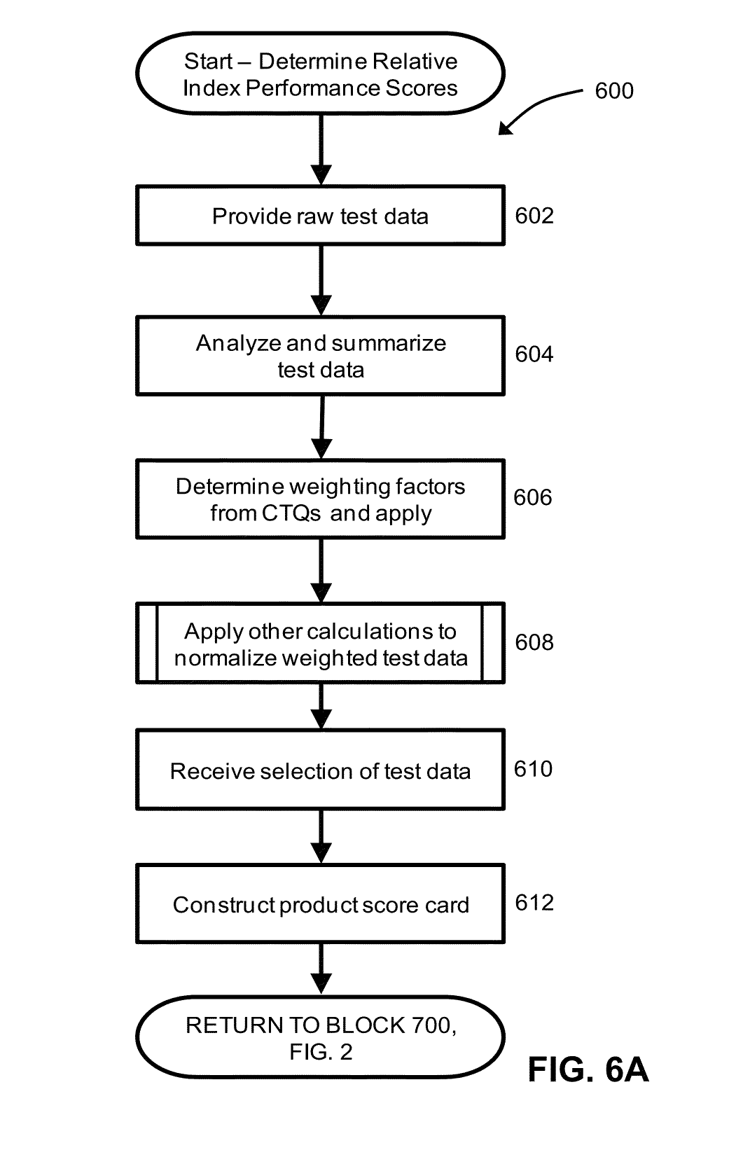

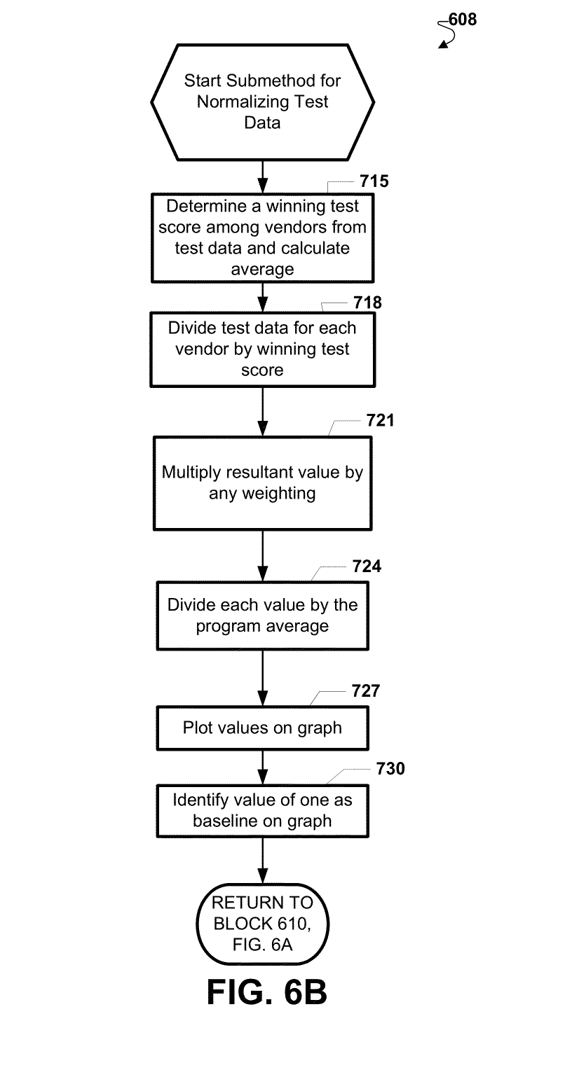

Referring now to FIG. 6A and FIG. 8, details are now described for determining relative index performance scores—RIPS—and constructing product score cards within the PEVS process flow 200. Specifically, FIG. 6A is a logic flow diagram of a routine or submethod 600 of FIG. 2 that illustrates the determination of relative index performance scores and constructing product score cards.

Block 602 is the first step of routine 600. The determining RIPS routine 600 may include test labs providing raw test data over the computer network 215 to the host computer 104 in block 602. Alternatively, test labs may e-mail or transmit this test data to the PPIs who may then upload the test data over the computer network 215 to the host computer 104.

PPIs may analyze and summarize test data using PPI portal 120 in block 604. This analyzing and summarizing of test data is illustrated in FIG. 8 described in more detail below. In block 606, PPIs may determine weighting factors from CTQs in block 606 and applying these weighting factors to the raw test data. In block 608, using the PPI portal 120, PPIs may apply other calculations to normalize weighted test data.

Referring briefly to FIG. 8, this figure illustrates an exemplary product scorecard data table 708 constructed according to the routine 600 of FIG. 6A. Analyzed and summarized test data are shown in rows 909 through 916 of upper data table 708A for the aforementioned inverter generator example. Specifically, within this range of rows, column 900g of upper data table 708A shows data for the Actual Starting Wattage critical to quality (“CTQ”) parameter. More specifically, row 911, column 900g of upper data table 708A shows a data value for the product of Vendor 1 wherein the numerical value 2032 Watts represents a numerical average of a sample size of five products (see row 916 that lists total sample size across each of the five different CTQ parameters listed in row 908). Raw data used to determine this value could include individual unit test values of 2050, 2011, 2025, 2030 and 2044 Watts (not displayed in data table 708), wherein the numerical average of these values is 2032 Watts.

Alternatively, the median of these data points could have been used in which case the median value would be 2030 Watts. Other statistical measures may also be used and automatically populated using one or more software modules. If an individual test value were to deviate significantly from the average, that data point could be excluded or the test could be repeated with be the same or another unit. These calculations and the format of rows 909 to 916 in FIG. 8 may correspond with step 604 in FIG. 6A to provide analyzed and summarized test data. Similar calculations may be used to analyze and summarize raw test data for the other CTQ parameters.

FIG. 8 also illustrates weighting factors in rows 904 and 907. Weighting factors may be determined from CTQ parameters depending upon the CTQ parameter category and the specific tests used to evaluate the particular CTQ parameter. For example, the overall Power Performance CTQ parameter (row 903 of the upper data table with columns 900e and 900i) may be evaluated using the five separate tests listed in row 908 columns 900e through 900i of upper data table 708A (Actual Running Wattage/Stated vs. Actual Running/Actual Starting Wattage, etc.).

Product performance intermediaries (“PPIs”) and/or clients may determine individual weighting factors (row 907 of upper data table 708A) toward an overall CTQ parameter weighting factor (row 904). For example, Actual Running Wattage comprises 25% of the weighting for the overall Power Performance CTQ parameter (row 907, column 900e). Individual weighting factors may comprise the critical to quality (“CTQ”) parameter when a single test is needed to evaluate the CTQ parameter. For example, the Noise CTQ parameter (column 900o, lower data table 708B) may be evaluated using a single test.

Individual weighting factors may be applied to the analyzed and summarized test data which correspond with step 606 in FIG. 6A. For example, consider the Ease of Use CTQ parameter shown in FIG. 8, column 900L of lower data table 708B. Scores for this Ease of Use CTQ parameter are listed in rows 909 through 914 for Vendors 1 through 6 respectively. The average value for Ease of Use is 1.08 as shown in row 915, column 900L.

A relative index performance score (“RIPS”) for this Ease of Use CTQ parameter for the product of Vendor 1 may be calculated by finding a “winning test score” (in this case, the highest value) in this category (value of 1.29 in row 914, column 900L which is for the sixth vendor), then dividing the score for Vendor 1 (value of 1.13 in row 909) by the winning test score value (1.29), and then multiplying by the weighting factor of 100% (multiplicative factor of 1.0 in row 907, column 900L), then multiplying by the weighting factor of 20% (multiplicative factor of 0.2 in row 904, column 900L). The resulting RIPS for the Ease of Use CTQ parameter for the product of Vendor 1 is 0.877. Using this calculation method, the numerical values for the Ease of Use CTQ parameter for the products of Vendor 1 through Vendor 6 are 0.877, 0.835, 0.805, 0.805, 0.701, 1.000 and 0.837 respectively.

RIPS for the other individual CTQ parameters of Power Performance (columns 900e through 900i, upper table 708A), Reliability (columns 900j and 900k, lower table 708B), Fuel Efficiency (columns 900m and 900n, lower table 708B), Noise (column 900o, lower table 708B) and Cold Start (column 900p, lower table 708B) may be calculated in a similar manner where a linear pattern exists or using a different modeling technique embedded in the system such as a log scale. RIPS for the individual CTQ parameters may also be summed together to form an overall RIPS for a given product.

In routine block 608 of FIG. 6A, other calculations may be applied to normalize weighted test data. For example, the Noise CTQ parameter in FIG. 8, column 900o in lower table 708A is measured in units of dB where dB represents decibels measured according to the customary logarithmic scale as understood by one of ordinary skill in the art. A RIPS for this CTQ parameter for the product of Vendor 1 may be calculated by subtracting the minimum value in this category (numerical value of 67.7 in row 913, lower data table 708B) from the CTQ value for Vendor 1 (numerical value of 73.6 in row 909, lower data table 708B), multiplying the difference by a weighting factor of 0.1, then subtracting from 1.

The resulting RIPS for the Noise CTQ parameter for the product of Vendor 1 is 0.412. Such alternative calculations may be used to scale numerical values to be nearer a scale of zero-to-one and can also be used to account for non-linear measurement scales. Alternative calculations may also be used to scale overall RIPS, wherein such scaling provides an average RIPS of one for all products. Further details of routine 608 in which test data is normalized will be described in detail below in connection with FIG. 6B.

Weighting factors in the scorecard data table 708A include rows 904 and 907. A first CTQ parameter of “power performance” is listed in row 903, while additional CTQ subparameters for power performance are listed in row 908: actual running wattage (column 900e), stated vs. actual running wattage @ full load (column 900f), actual starting wattage (column 900g), stated vs. actual starting wattage @ max load (column 900h), and power cleanliness (column 900i). In other words, Row 903 listing “Power performance” summarizes the one or more CTQ subparameters being evaluated in row 908. Row 908 usually tracks individual test information for a particular product.

For the second, lower data table 708B in row 903 tracks the following CTQ parameters: reliability (columns 900j and 900k), ease of use (column 900L), fuel efficiency (columns 900m and 900n), noise (column 900o), and cold start (column 900p). Meanwhile, row 908 of data table 708B the names of CTQ subparameters derived from the following individual tests: life threshold 900j, unit failures 900k, ease of use 900l, fuel consumption 900m, run time 900n, noise 900o, and cold start 900p. Analyzed and summarized test data from block 604 of FIG. 6 may comprise information in rows 909 through 915 of each data table 708A, 708B that are supplied by each vendor through test portal 150 of FIG. 1 after tests on a product have been conducted.

One of ordinary skill in the art recognizes that additional or fewer rows may be used to represent additional or fewer products, respectively. Row 916 of upper data table 708A and lower data table 708B may list how many samples/products were tested. One of ordinary skill in the art recognizes that alternative tabular arrangements of such CTQ parameters are within the purview of the inventive system 100. Such alternative arrangements may include a single table of information as compared to the split-table illustrated in FIG. 9.

Referring briefly back to FIG. 6A (while also referring to at least one column in FIG. 8), at block 610, the computer server 104 may receive a selection of test data such as a column of data points for a single CTQ subparameter. For example, data points from rows 909 to 914 of a particular column, like from a column of anyone of columns 900e through 900i of data table 708A or from anyone of columns 900j through column 900p of data table 708B.

Once the data points are selected from the column 900 in the data table 708, then in block 612, a product scorecard 710 may be constructed after a create scorecard command and/or button 612 is selected as illustrated in FIG. 8. Further details about product scorecards 710 will be described below and are illustrated in FIGS. 9-10 and 13-18. Upon completion of routine 600, the process may then return to routine 700 of FIG. 2.

### Routine 608: Normalizing Test Data

Referring now to FIG. 6B, this figure is a logic flow diagram of a routine or submethod 608 of FIG. 6A that illustrates how to normalize test data. Block 715 is the first step of routine 608. In block 715, a winning test score among vendors is determined from test data as well as the average for this test data. In this block 715, this winning test score may comprise the highest value among a set of values or the lowest value of a set of values. Alternatively, it could comprise a median value or a mean value from a set of values. The “winning test score” is dependent on the type of test that is applied to a group of products. The computer server 104 may determine this winning test score from the test data.

Once the winning test score is determined, then in block 718, each value from the test data is divided into or by (depending on the test) the winning test score. Next, in block 721, the resultant value from block 718 is multiplied by any weighting values for the test which are determined in block 606 of routine 600 of FIG. 6A. In some instances, there may not be any weighting values for a test. In such instances, the weighting value would be assigned a value of one. Exemplary output from block 721 is illustrated in FIG. 9C in the column labeled “Total Index Score” which will be described in further detail below.

Next, in block 724, each value from block 721 is divided by the average of the test data which was calculated in block 715. Then, in block 727, the values from block 724 are then plotted on a graph. An exemplary graph is illustrated in FIG. 9D described in further detail below. This graph may be referred to as a product scorecard. In block 730, the value of one (1.0) is identified on the graph as the baseline. See the dashed line of FIG. 9D. The routine then returns to block 610 of FIG. 6A.

While the exemplary embodiment of FIG. 6B illustrates normalizing test data by dividing each test score (data) by the winning test score, one of ordinary skill in the art recognizes that this normalizing/indexing of test data (test scores) to create a RIPS is just one exemplary way and that other ways to normalize or index the test data are possible. For example, other indexing methodologies may include customizing scales on the x-axis and y-axis for graphs. Other indexing methods may include using logarithmic scales. Therefore, the inventive system 100 illustrated in FIG. 1A is not limited to the exemplary normalizing or indexing submethod illustrated in FIG. 6B. Other normalizing/indexing techniques may be employed without departing from the scope of this disclosure for the inventive system 100.

One of ordinary skill in the art recognizes that the techniques for normalizing test data with a winning test score are dependent on the type of test being evaluated. For example, if a product being tested is a drill bit and a first test is the number of holes that each drill bit among a group of drill bits may complete over their lifetime, then a winning test score among drill bits would be the highest number of holes drilled among the drill bits being tested. If the highest number of holes drilled in this example were ten (the winning test score), then all other number of holes drilled would be divided by this value of ten (the winning test score).

If a second test is how fast each drill bit may drill a hole, then the winning test score would be the lowest time value of the time values tracked for all the drill bits being tested. Depending on the amount of time measured, other non-winning scores for this drill bit time could be divided by or divided into the winning test score.

Referring now to FIG. 9A, an exemplary graphical representation of a RIPS or scorecard 710A created in routine 600 of FIG. 6A is illustrated. Specifically, FIG. 9 is an exemplary graphical user interface comprising a graphical representation of an overall relative index performance scores (“RIPS”) scorecard 710. The numerical values above each of the bars 1005A-F of scorecard 710 may represent the overall RIPS for each product whose calculation has been made similar to those described above in connection with the data tables 708 of FIG. 8.

Bar Charts 1005A-F may be arranged with products that have the highest overall RIPS toward the left, with lower RIPS toward the right in a descending order. The dashed line 1010 may represent the program average score (which also corresponds to one column of row 915 of either data table 708A or 708B in FIG. 9). It is understood that alternative graphical arrangements of such scorecard information are within the purview of the inventive system 100.

FIG. 9A further comprises graphical icon 989 that may include a video button. This screen element 989 may activate a video clip and/or it may comprise a link to a website that stores video. The graphical icon 989 may be selected after one of the bar charts 1005 is selected by an operator. The videos associated with the video icon 989 may comprise ones that show actual testing of a product for one of the vendors. In this way, if an operator desires to view a test for a particular product associated with a particular vendor, then the bar chart 1005 associated with a particular vendor may be selected in combination with the video icon 989.

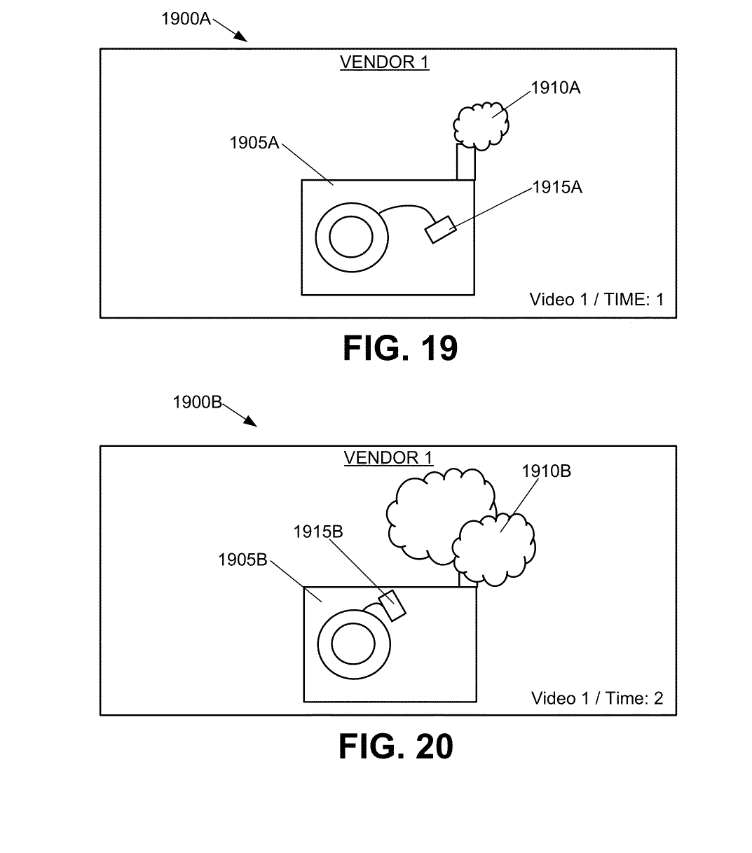

Then, the computer 104 would retrieve a video for a test of the product associated with the particular bar chart 1005 which was selected by an operator. Alternate ways for allowing videos of product testing to be selected and viewed by an operator are within the scope of this disclosure. An exemplary video clip of a test is illustrated in FIGS. 19-20 which will be described in further detail below. The video clip the test illustrated in FIGS. 19-20 may be displayed upon the activation of the video icon 989.

Referring now to FIG. 9B, this figure illustrates an exemplary product scorecard data table 708C constructed according to the routine of FIG. 6A. The data table 708C comprises data from an “Ease of Pull/Start” test for five inverter generators from five vendors: Vendors 1-5. The “winning test score” for this data is the lowest value among all five values. This means that Vendor 1 has the lowest value at 1.04%. Therefore, as a result of block 715 (determining the winning test score), the computer server 104 would select 1.04% corresponding to Vendor 1. One of ordinary skill in the art recognizes that the inventive system 100 is not limited to this exemplary test and the corresponding data shown. Other tests and test data values may be employed without departing from this disclosure.

FIG. 9C illustrates an exemplary product scorecard data table 708D constructed according to the routine of FIG. 6B. In this exemplary scorecard data table 708D, the percentage (%) column is derived from blocks 718-724. Specifically, the values from the “Ease of Pull/Start” column of scorecard data table 708C are all divided by the winning score of 1.04 (of Vendor 1) (Block 718) and then multiplied by the weighing value (which is 1.0 or 100%—see weightings row of data table 708C, second row) (Block 721).

Next, the three digit values of the percentage (%) column of scorecard data table 708D of FIG. 9C are rounded to two digits to yield the values in the third column labeled as the “Total Score” column. Then, the values of the “Total Score” are divided by the program average of 0.69 (see last row of scorecard data table 708D) (Block 724). This action yields the values of the last column of scorecard data table 708D of FIG. 9C labeled as the “Total Index Score.”

FIG. 9D is an exemplary graphical user interface comprising a graphical representation of an overall relative index performance scores type scorecard 710A2 in which data has been normalized. Scorecard 710A2 corresponds with the last column of scorecard data table 708D of FIG. 9C labeled as the “Total Index Score” and with block 727 of FIG. 6B. As noted above, block 727 is a plotting step in which the values from this step are plotted in a graph such as a bar chart as illustrated in FIG. 9D.

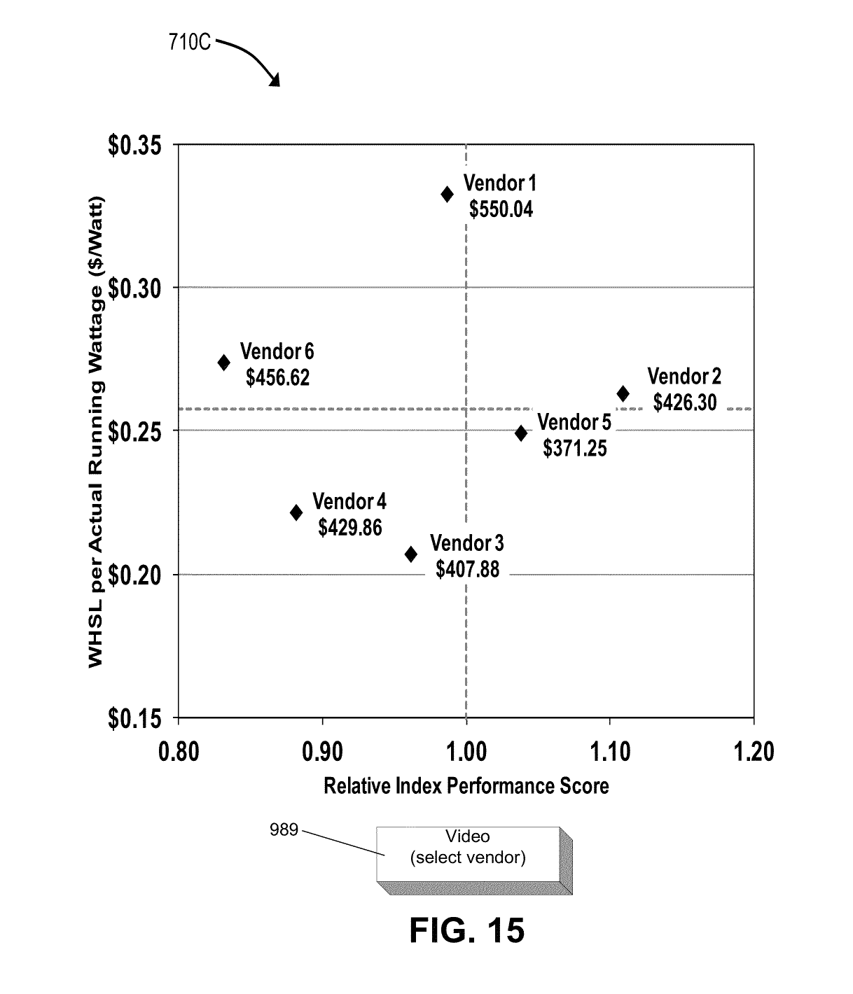

Referring now to FIG. 10, an exemplary arrangement for a single page “at a glance” scorecard 710B is illustrated. Specifically, FIG. 10 is an exemplary graphical user interface comprising an arrangement of a single page “at a glance” scorecard 710B. Such a scorecard 710B may include a data table 708 (display of FIG. 8), a graphical presentation of RIPS scorecard 710A1 (display of FIG. 9A), and a graphical display of cost vs. RIPS scorecard 710D (display of FIG. 15). It is understood that alternative arrangements of these displays are within the purview of the inventive system 100. For example, the relative sizes and positioning of these displays may be adjusted without departing from this disclosure as understood by one of ordinary skill in the art. It is understood that PPIs can arrive at a satisfactory scorecard after several iterations. FIG. 10 further comprises the video icon 989 which may be selected in combination with the selection of a particular vendor in order to display a video of a test for a particular product as described above in connection with FIG. 9A.

### Routine 700: Modifying a Product Scorecard

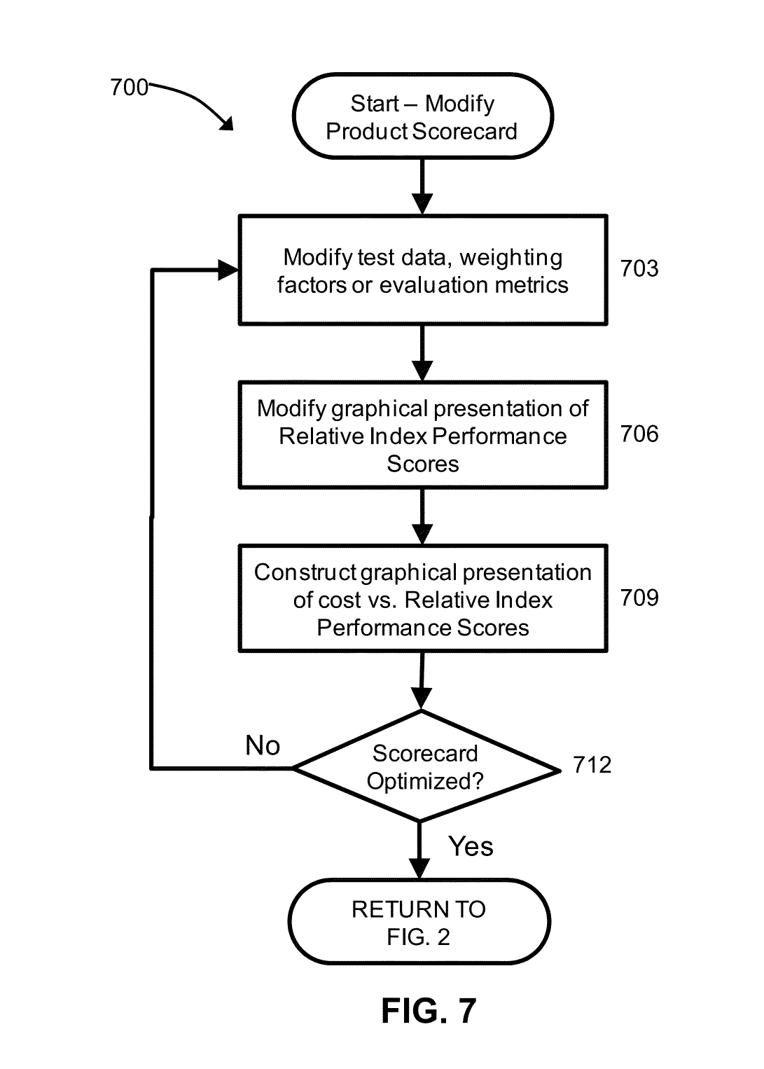

Referring now to FIG. 7, details are now described for a modifying a product scorecard routine 700 within PEVS process flow 200 of FIG. 2. Specifically, FIG. 7 is a logic flow diagram of a routine or submethod 700 of FIG. 2 that illustrates modification of product scorecards. Block 703 is the first step of routine 700.

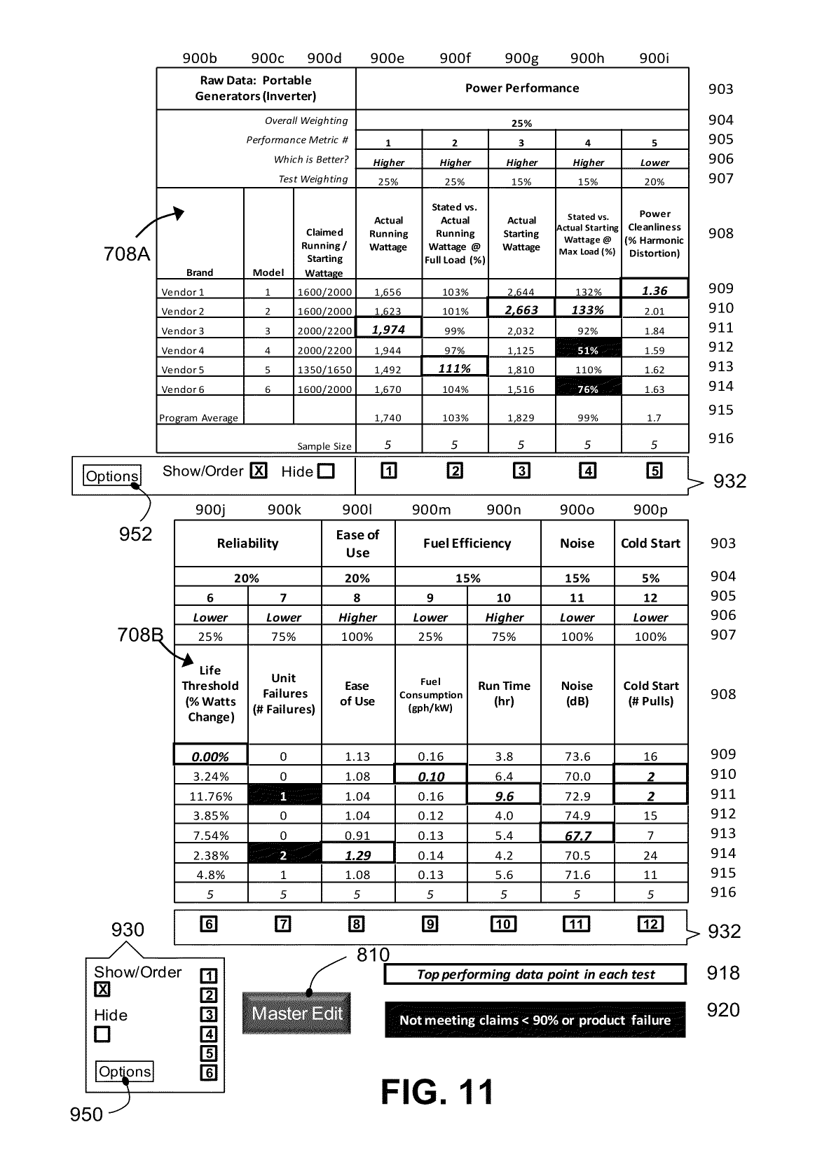

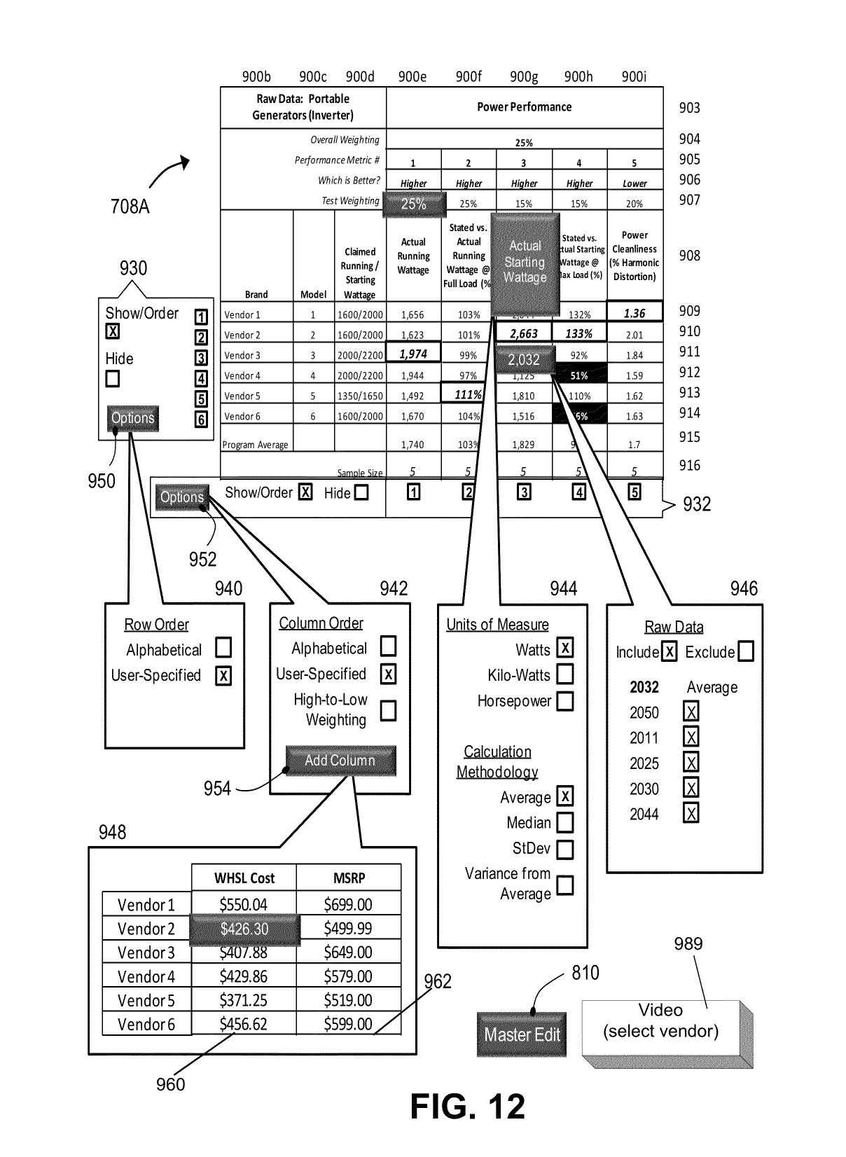

Clients may retrieve and display scorecards 710 by using the client portal 110 of FIG. 1A. Modified test data, modified weighting factors, or modified evaluation metrics may be received from the client portal 110 in block 703. For example, additional dialogue boxes for receiving and/or manipulating data may be generated as illustrated in FIGS. 11 and 12 and described below. These dialogue boxes may be generated in response to a master edit button 810 as illustrated in FIGS. 8 and 11 being selected. Next, in block 706, data for modifying graphical presentation of RIPS scorecards 710 may be received from the client portal 110.

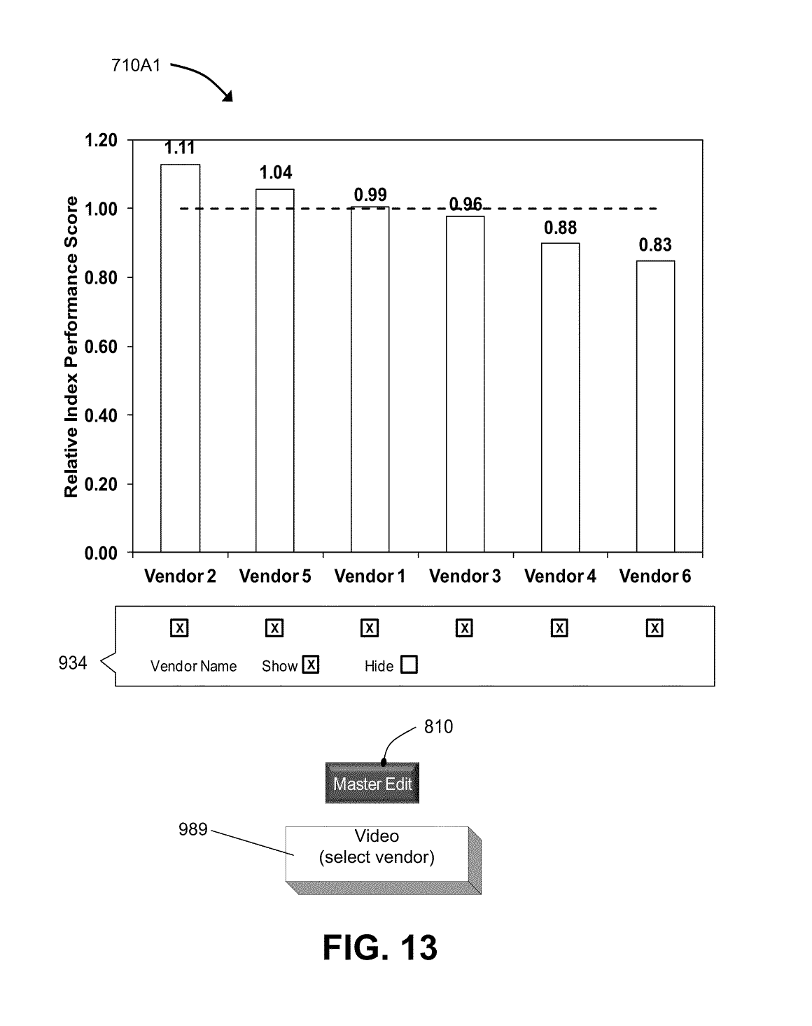

For example, additional dialogue boxes for receiving and/or manipulating data may be generated as illustrated in FIG. 13 and described below. In block 709, a graphical representation of cost vs. RIPS scorecard 710D as illustrated in FIG. 15 may be constructed. Further details of FIG. 15 will be described below. In decision block 712, it is determined whether the modified scorecard 710 is acceptable. Decision block 712 waits for operator input from the client portal 110. Once decision block 808 is satisfied in the affirmative, then the “YES” branch may be followed in which the modified scorecards 710 may be stored within the computer server 104 and the process returns back to FIG. 2 in which the process ends.

Referring briefly back to FIG. 8, a scorecard modification routine 700 may be explained for the inverter generator example. The scorecard modification routine 700 may be initiated by a client selecting Master Edit button 810 of FIG. 8. Upon selection of button 810, the system 100 may change in visual appearance such as changes to color and/or font size. Additional editing features/graphical user interfaces may be displayed on the scorecard data table as illustrated in FIG. 11.

Referring now to FIG. 11, this figure is a graphical user interface comprising an exemplary product scorecard data table 708 of FIG. 8 enabled for editing once the master edit button 810 has been selected. After the master edit button 810 has been selected, additional scorecard editing features may be presented on the display, which include dialogue boxes 930 and 932. One of ordinary skill in the art will appreciate that other ways to manipulate data in the data tables 708 as well as the scorecards 710 are possible, such as drop and drag features, and that the inventive system 100 is not limited to the graphical methods shown.

Dialogue box 930 may be used to show, hide, disguise names (e.g., change an actual vendor name to a generic name) and/or reorder rows 909 to 914. For example, if the client can move the product of Vendor 3 to the top of the list by typing a “1” in the show/order box for Vendor 3 in row 911. A client can hide rows for one or more products by clearing the show/order boxes for those products. Dialogue box 932 can be used to show, hide and/or reorder columns 900e to 900p in a similar manner. Dialogue boxes 930 and 932 can further include Options buttons 950 and 952 (respectively).

Referring now to FIG. 12, this figure is a graphical user interface of the scorecard data table 708 of FIG. 8 with additional menu features displayed. Columns 900j to 900p (corresponding to lower data table 708B) are omitted from FIG. 12 for clarity. In FIG. 12, options button 950 may be selected to invoke additional options for row order. Upon selection of button 950, the computer server 104 changes visual appearance and a drop-down menu 940 is displayed. Menu 940 may include additional options for row order including an option for sorting in alphabetical order.

Similarly, options button 952 may be selected to invoke additional options for column order. Upon selection of button 952, the display may change in visual appearance and drop-down menu 942 may be displayed. Menu 942 may include additional options for column order including options for sorting in alphabetical order and in order of highest-to-lowest test weighting. Menus 940 and 942 may be made to disappear by deselecting option buttons 950 and 952 (respectively). Menu 942 may further include an add column button 954.

Upon selection of button 954, the display may change in visual appearance and a sub-level drop-down menu 948 can be displayed. Menu 948 may be used to add one or more columns with additional data for the products. For example, on a first push of button 954, column 960 may be displayed and populated as shown, including the column header. On a second push/activation of button 954, column 962 can be displayed and populated as shown including the column header. Alternatively, columns 960 and 962 can be displayed adjacent and right of column 900p, wherein columns 960 and 962 can be hidden upon deselecting Master Edit button 810, or by selecting the hide option now present for each new column.

Still referring to FIG. 12, “mouse over event” features (as known to one of ordinary skill in the art) may be enabled and used to for data field entry and to display additional dialogue boxes. For example, weighting factors in rows 904 and 907 may be changed by moving a display cursor over those data fields wherein holding the cursor over a given field causes it to change visual appearance and also be enabled for value change (e.g., “25%” in row 907, column 900e may be changed to another value). The client may utilize client portal 110 to display and modify the weighting factors in rows 904 and 907 of both data tables 708A and 708B (while only the first, upper data table 708A is displayed in FIG. 12).

Mouse over events for fields in rows 909 to 915, columns 900e to 900p may cause the fields to change in visual appearance and may also cause menu 946 for raw data to be displayed. In FIG. 12, menu 946 corresponds to the field in row 911, column 900g. Data values 2050, 2011, 2025, 2030 and 2044 correspond to the five individual Actual Running Wattage tests for the product of Vendor 3, and may be modified to exclude a point or points from the calculation. A statistical measure of the data points may also be displayed, in this case an average value of 2032. The statistical measure may be changed using menu 944 as will be discussed below.

Mouse over events (or other similar screen/display pointer events) for fields in row 908 may cause menu 944 to be displayed. Menu 944 may be used to change units of measure for a given column of data. For example, data in row 900g are displayed in Watts, but can also be displayed in Kilo-Watts by selecting the Kilo-Watts select box. Optional units of measure may be pre-selected by PPIs as part of scorecard construction and used to populate menu 944.

Menu 944 may also be used to change the calculation methodology for the statistical measure of a data field. In menu 944, the box for calculating “Average” may be selected, thereby causing the numerical average to be used for data points in menu 946. Other calculation methodologies such as median and StDev (standard deviation) may also be used/selected. Menus 944 and 946 may be made to disappear by selecting another data field in data table 708. FIG. 12 further comprises the video icon 989 which may be selected in combination with the selection of a particular vendor in order to display a video of a test for a particular product as described above in connection with FIG. 9A.

Referring now to FIG. 13, this figure is a graphical user interface comprising a graphical representation of the relative index performance scorecard 710A of FIG. 9 enabled for editing. Selecting Master Edit button 810 (that is displayed when a screen pointer or mouse over event occurs) may cause a dialogue box 934 to be displayed.

Dialogue box 934 may be used to show and hide the vendor names associated with individual RIPS. A client via a portal 110 may use this option to show a particular vendor his product score relative to the others without disclosing the names of the other vendors. FIG. 13 further comprises the video icon 989 which may be selected in combination with the selection of a particular vendor in order to display a video of a test for a particular product as described above in connection with FIG. 9A.

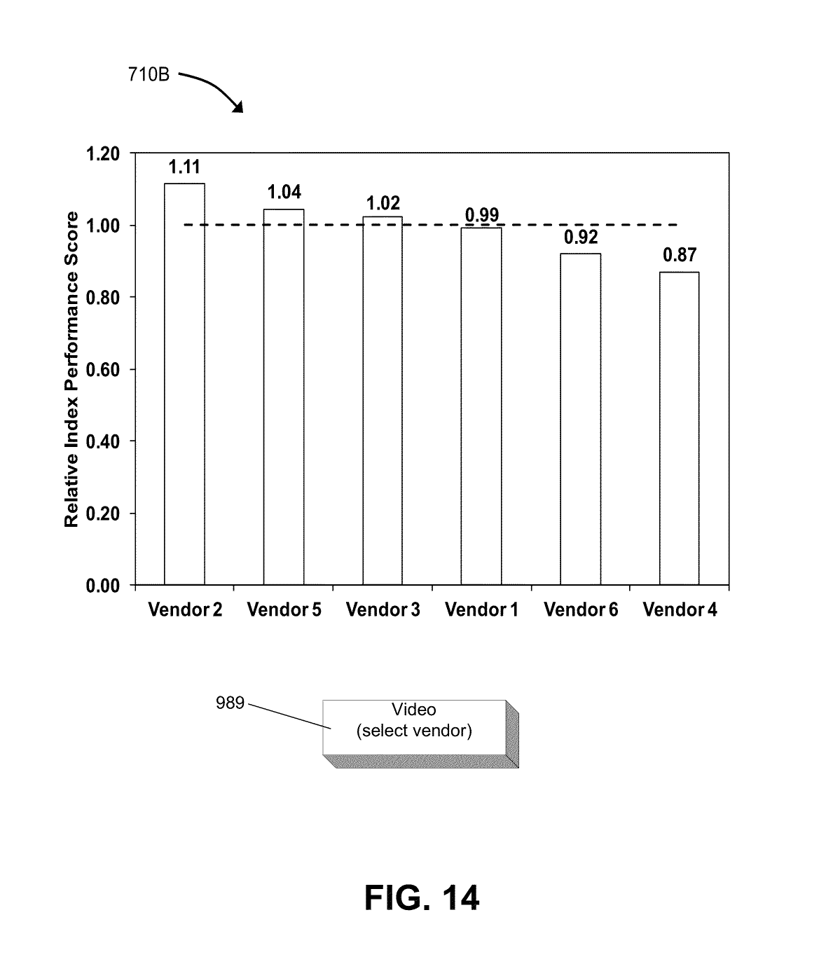

Referring now to FIG. 14, a modified graphical representation of a RIPS scorecard 710C that includes the effect of the weighting changes. Specifically, FIG. 14 is a graphical user interface comprising graphical representation of the relative index performance scorecard 710A of FIG. 9 modified according to the routine of FIG. 7.

Weighting factors for Power Performance and Reliability CTQs are 25% (overall performance, row 904, table 708A—FIGS. 8) and 20% respectively (row 904, table 708B, table 708B—FIG. 8). A client may decide that weighting factors of 35% and 10% (respectively) are more appropriate and better represent user CTQs. The client can utilize client portal 110 to display and modify the weighting factors as previously described in connection with FIG. 11.

The changes in weighting factors (35% and 10% noted above) move Vendor 3's product from 4^{th} place to 3^{rd} place, and move Vendor 6's product from 6^{th} place to 5^{th} place when comparing product score card 710A of FIGS. 9 and 13 to product scorecard 710B of FIG. 14. As noted previously, the RIPS data illustrated in FIGS. 9A, 13, and 14 comprises summary values for RIPS which are not illustrated in data tables 708 of FIGS. 8 and 11. FIG. 14 further comprises the video icon 989 which may be selected in combination with the selection of a particular vendor in order to display a video of a test for a particular product as described above in connection with FIG. 9A.

Referring now to FIG. 15, a graphical representation of product cost to the consumer vs. RIPS is illustrated. Specifically, FIG. 15 is a graphical user interface comprising an exemplary graphical representation of product cost to the consumer vs. overall relative index performance scores (“RIPS”)—scorecard 710C. Such a graphical display can be used to compare the product cost to the consumer against RIPS with data entered using menu 948 (FIG. 12).

Data points in FIG. 15 can be plotted with RIPS on the horizontal axis, and a cost metric on the vertical axis. In this example the cost metric is determined by dividing the wholesale product cost—shown adjacent to each data point—by the Actual Running Wattage (column 900e in FIG. 8). Calculations such as these can be used to account for differences in product design, packaging, etc.—in this case to account for somewhat different inverter generator capacities. Such graphical representations can provide clients with visual comparisons of product cost relative to RIPS, e.g., product cost relative to those features perceived to be valuable by a product user.

One exemplary interpretation of FIG. 15 is that the product of Vendor 1 provides similar user value as the product of Vendor 3 but at a far higher product cost. The product of Vendor 2 can be viewed to provide superior user value but at a moderately higher product cost relative to Vendor 3. Other types of product cost to consumer vs. RIPs comparisons are within the purview of the inventive system 100. For example, each manufacturer's suggested retail price (“MSRP”) could be used instead of the product cost to the consumer for the scorecard 710C. FIG. 15 further comprises the video icon 989 which may be selected in combination with the selection of a particular vendor in order to display a video of a test for a particular product as described above in connection with FIG. 9A.

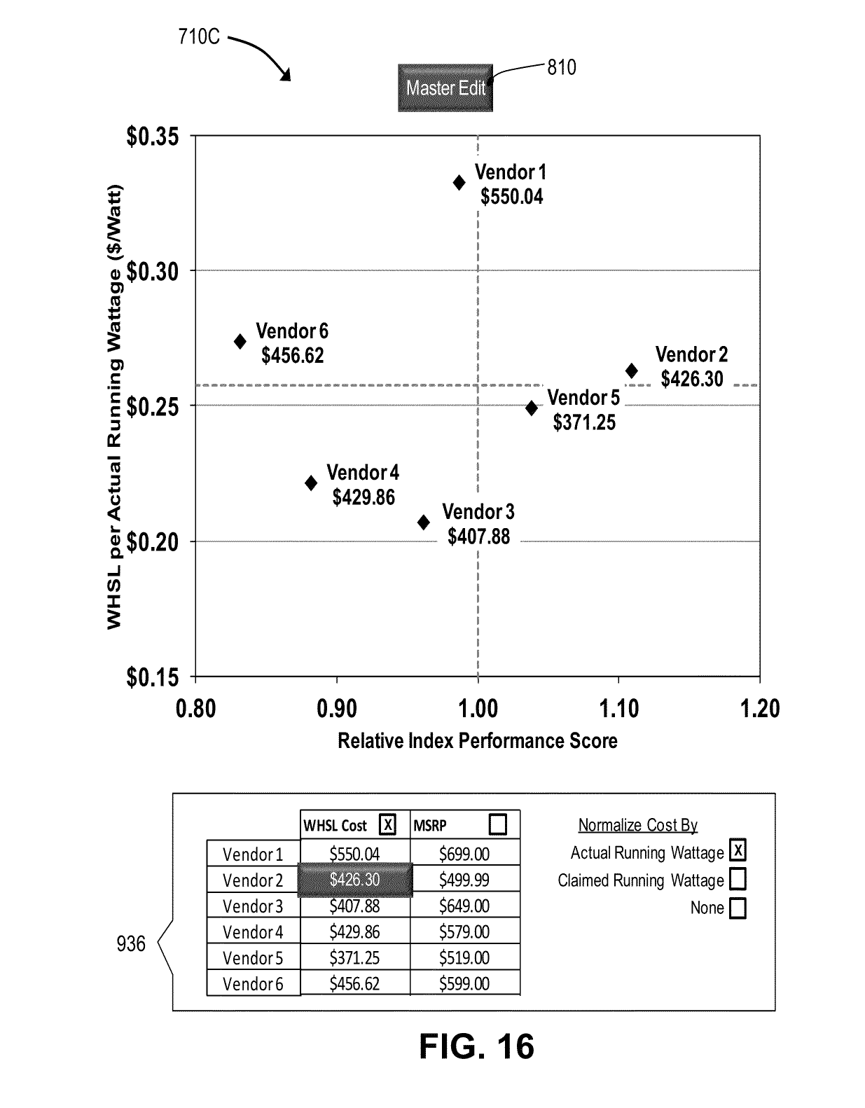

Referring now to FIG. 16, selecting Master Edit button 810 (button 810 being displayed in response to a mouse over/screen pointer event) may cause dialogue box 936 to be displayed on the graphical representation of product cost to the consumer vs. RIPS scorecard 710C. Specifically, FIG. 16 is a graphical user interface comprising a graphical representation of cost vs. overall relative index performance scores—scorecard 710C but now enabled for editing.

The Y-axis of scorecard 710C may be modified using the values for cost data that may be entered as previously described for menu 948 in FIG. 12, but are now displayed and available for changes in dialogue box 936 of FIG. 16. These changes are reflected in a new Y-Axis. Variables used to normalize cost data can also be changed. For example, Claimed Running Wattage may be used instead of Actual Running Wattage. The data for scorecard 710C of FIG. 16 has not been changed even though dialogue box 936 has been displayed and which will allow for changes to be made by an operator.

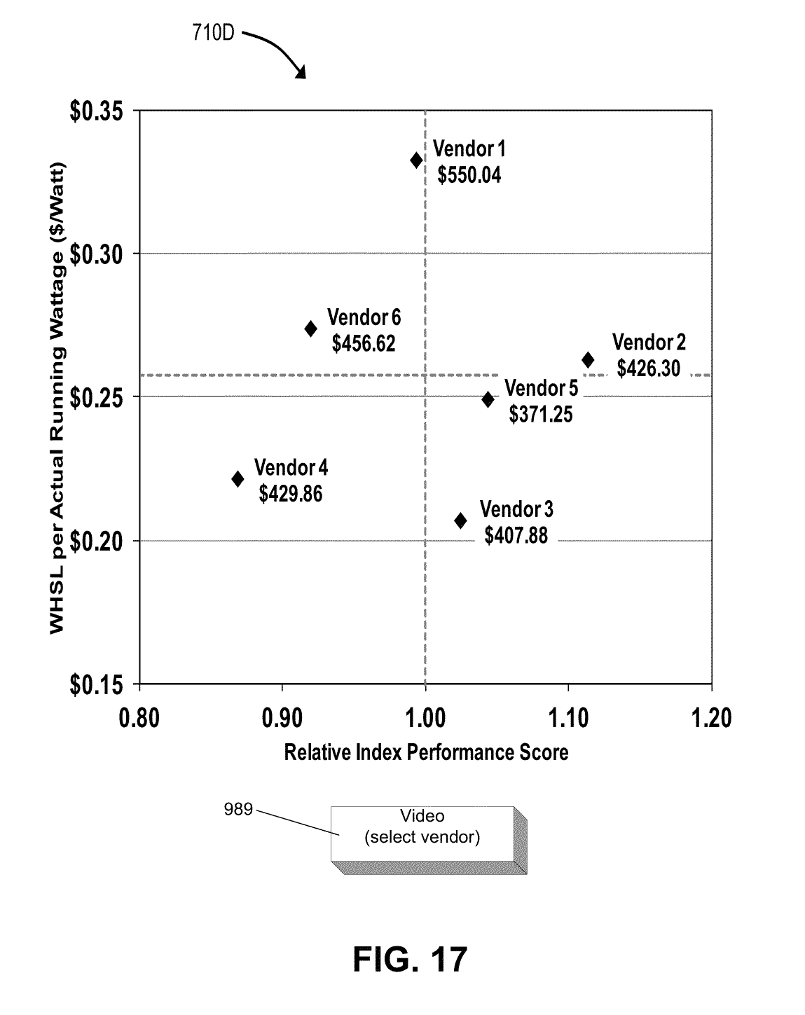

Referring now to FIG. 17, scorecard 710D which is a modified version of scorecard 710C of FIG. 15 is illustrated. Specifically, FIG. 17 is a graphical user interface for the graphical representation of FIG. 16 modified according to the routine of FIG. 7. FIG. 17 shows product cost to consumer vs. RIPS scorecard 710D according to a scorecard modification wherein weighting factors for Power Performance and Reliability CTQs were changed from 25% and 20% (respectively) to 35% and 10% (respectively). Data in FIG. 17 for scorecard 710D may be interpreted that the products of Vendors 3 and 6 provide better user value as compared to results of the product scorecard 710C of FIG. 16.

Clients (such as product retailers who sell products originating from a range of different product vendors) may also consider price markup (e.g., difference between wholesale price and MSRP) towards making changes to weighting factors. For example if the product of Vendor 1 had a very high markup, the retailer could use FIG. 17 to influence Vendor 1 to lower the price of their product. FIG. 17 further comprises the video icon 989 which may be selected in combination with the selection of a particular vendor in order to display a video of a test for a particular product as described above in connection with FIG. 9A.

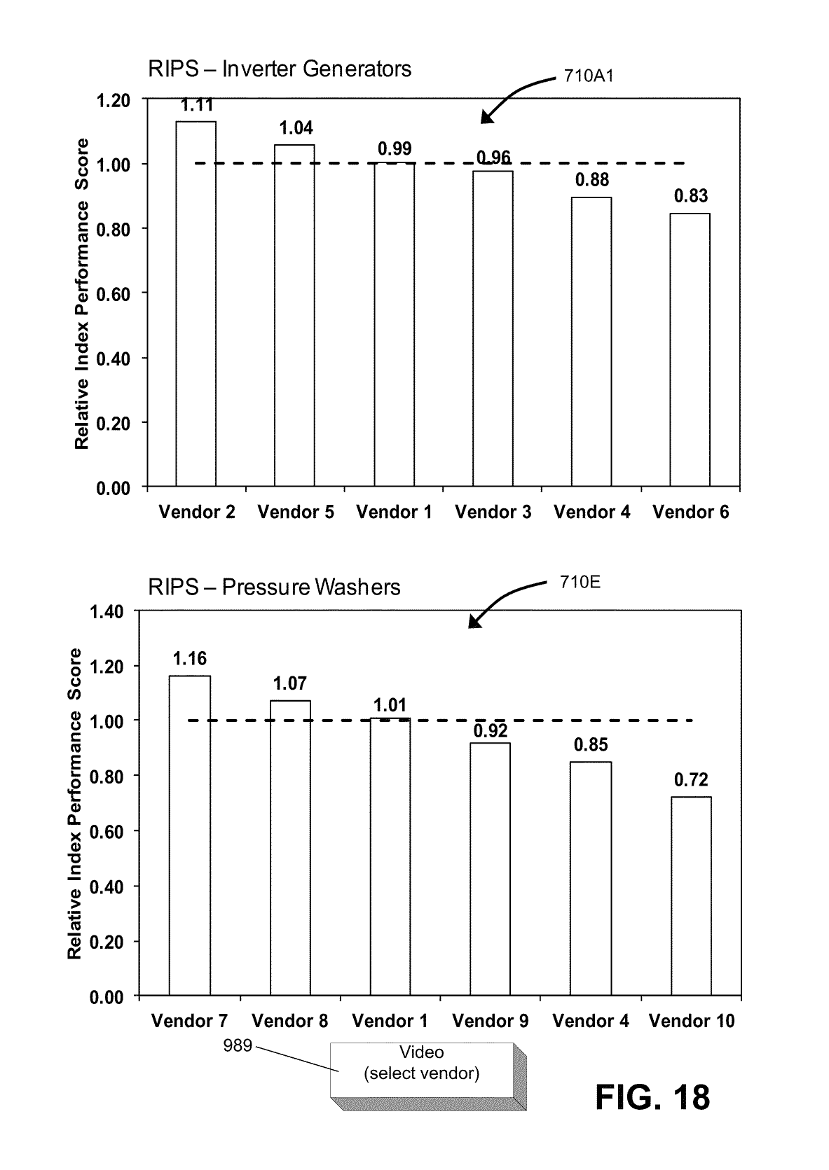

In another type of visual display for the inventive system 100, clients may evaluate relative performance not just for one product category, but for several product categories. For example, in FIG. 9A the inverter generator overall RIPS illustrated shows a performance range of 0.28 (derived by subtracting the score of 0.83 for Vendor 6 from the score of 1.11 from Vendor 2), or 0.11 points above the program average (score of 1.11 for product of Vendor 2) and 0.17 points below the program average (score of 0.83 for product of Vendor 6). Given the indexing methodology about a consistent normalized value (the value of one determined from normalized product category program averages), a client may compare the performance of inverter generators to the performance of pressure washers and/or other products, such as illustrated to FIG. 18.

FIG. 18 is a graphical user interface that comprises two scorecards 710A, 710E that compare product scores for two different types of products, such as an inverter generator for scorecard 710A1 and pressure washers for scorecard 710E. In this exemplary embodiment, Vendor 4 supplies both products to client (such as a retailer) and those products are both underperforming by a reasonable percent (i.e., 0.12 below program average on inverter generators with a value of 0.88 in scorecard 710A1 and 0.16 below average on pressure washers with a value of 0.86 in scorecard 710E).

Second, the pressure washer product of Vendor 10 as illustrated in scorecard 710E is significantly below average (0.28 below program average) relative to other pressure washers. Both of these examples provide significant negotiating leverage for the client (such as a retailer) over the vendors and would not be attainable without the present inventive system 100. FIG. 18 further comprises the video icon 989 which may be selected in combination with the selection of a particular vendor in order to display a video of a test for a particular product as described above in connection with FIG. 9A.

Referring now to FIG. 19, this figure is an exemplary graphical display of a first window 1900A comprising a first frame of video of a product test. This first window 1900A may be displayed in response to the activation of the video icon 989 which may be selected in combination with the selection of a particular vendor from a particular product scorecards 710 described above.

This first frame of video comprises an inverter generator 1905A that includes a hand pull cord 1915A. The video may illustrate how exhaust 1910A is produced while the inverter generator 1905A is running The video may comprise video taken during one of the product tests described above. The video is not limited to the inverter product shown and each video may comprise other products and corresponding product tests as understood by one of ordinary skill in the art.

This video may be stored on the computer server 104 of FIG. 1A. Alternatively, the video may be stored on another computer server 104 operated by a third party, such as the YOUTUBE(TM) brand video servers. In such a scenario, the video icon 989 may comprise a link to computer servers 104 operated by a third party.

FIG. 20 is an exemplary graphical display of a second window 1900B comprising a second frame of video of a product test corresponding to FIG. 19. FIG. 20 is similar to the video of FIG. 19 so only the differences between FIGS. 19 and 20 will be described. This second frame of video in FIG. 20 occurs or happens after the first frame of video in FIG. 19.

According to this exemplary embodiment, the inverter generator 1905B has produced more exhaust 1910B which occupies a greater volume compared to the exhaust 1910A of FIG. 19. Also, the hand pull cord 1915B has further retracted into a take-up reel of the inverter generator 1905B compared to the hand pull cord 1915A of FIG. 19. As noted above, the video may comprise video taken during one of the product tests described above. The video is not limited to the inverter product shown and each video may comprise other products and corresponding product tests as understood by one of ordinary skill in the art.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology, have enabled numerous PCDs with multiple capabilities. Therefore, a PCD may be a cellular telephone, a satellite telephone, a pager, a personal digital assistant (“PDA”), a smartphone, a navigation device, a smartbook or reader, a media player, a combination of the aforementioned devices, a tablet personal computer (“PC”), and a laptop computer with a wireless connection, among others.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source, such as in “cloud” computing, using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer implemented method for creating and monitoring critical to quality based product testing comprising:
receiving data from a computer network comprising one or more parameters that assess a quality of a product;
receiving data from the computer network comprising data for a one or more product test plans corresponding to the one or more parameters that assess a quality of the product;
monitoring one or more tests for the product corresponding to the one or more product test plans;
determining at least one relative index performance score from the one or more tests; and
creating at least one product score card based on the at least one relative index performance score.

2. The method of claim 1, further comprising transmitting the at least one product score card over the computer network.

3. The method of claim 1, further comprising creating a graphical display illustrating current progress of the one or more tests.

4. The method of claim 1, wherein the product score card comprises a graphical display illustrating performance of a plurality of products corresponding to the one or more tests.

5. The method of claim 1, further comprising determining a winning test score among the one or more tests.

6. The method of claim 5, further comprising normalizing at least one other test score with the winning test score.

7. The method of claim 6, wherein the step of normalizing at least one other test score with the winning test score comprises dividing each test score from a plurality of tests by the winning test score and plot resultant from each division on a graph.

8. The method of claim 1, further comprising receiving a request for displaying a video of a test.

9. The method of claim 8, further comprising transmitting data over the computer network that comprises video data for a test.

10. The method of claim 1, further comprising receiving data corresponding to one or more surveys for identifying one or more parameters that assess quality of a product.

11. A computer system for creating and monitoring critical to quality based product testing comprising:
a computer server for receiving data from a computer network comprising one or more parameters that assess a quality of a product, the server receiving data from the computer network comprising data for a one or more product test plans corresponding to the one or more parameters that assess a quality of the product; the computer server monitoring one or more tests for the product corresponding to the one or more product test plans; the computer server receiving data for determining at least one relative index performance score from the one or more tests; the computer server receiving data for creating at least one product score card based on the at least one relative index performance score; and the computer server transmitting the at least one product score card over the computer network.

12. The computer system of claim 11, wherein the computer server receives data for creating a graphical display illustrating current progress of the one or more tests.

13. The computer system of claim 11, wherein the product score card comprises a graphical display illustrating performance of a plurality of products corresponding to the one or more tests.

14. The computer system of claim 11, wherein the computer server determines a winning test score among the one or more tests.

15. The computer system of claim 14, wherein the computer server normalizes at least one other test score with the winning test score.

16. A computer program product comprising a computer usable medium having a computer readable program code embodied therein, said computer readable program code adapted to be executed to implement a method for creating and monitoring critical to quality based product testing, said method comprising:
receiving data from a computer network comprising one or more parameters that assess a quality of a product;
receiving data from the computer network comprising data for a one or more product test plans corresponding to the one or more parameters that assess a quality of the product;
monitoring one or more tests for the product corresponding to the one or more product test plans;
determining at least one relative index performance score from the one or more tests; and
creating at least one product score card based on the at least one relative index performance score.

17. The computer program product of claim 16, wherein the program code implementing the method further comprises:
determining a winning test score among the one or more tests.

18. The computer program product of claim 17, wherein the program code implementing the method further comprises:
normalizing at least one other test score with the winning test score.

19. The computer program product of claim 18, wherein the step of normalizing at least one other test score with the winning test score comprises dividing each test score from a plurality of tests by the winning test score and plot resultant from each division on a graph.

20. The computer program product of claim 16, wherein the program code implementing the method further comprises:
receiving a request for displaying a video of a test.
